(19) United States
(12) Patent Application Publication
(10) Pub. No.: US 2020/0124171 A1
(43) Pub. Date: Apr. 23, 2020

(54) CONTROL APPARATUS FOR VEHICLE DRIVE-FORCE TRANSMITTING APPARATUS

(71) Applicant: TOYOTA JIDOSHA KABUSHIKI KAISHA, Toyota-shi (JP)

(72) Inventors: Kunio HATTORI, Nagoya-shi (JP); Atsushi AYABE, Toyota-shi (JP); Yusuke OHGATA, Miyoshi-shi (JP); Shinji OITA, Toyota-shi (JP)

(73) Assignee: TOYOTA JIDOSHA KABUSHIKI KAISHA, Toyota-shi (JP)

(21) Appl. No.: 16/572,686

(22) Filed: Sep. 17, 2019

(30) Foreign Application Priority Data
Oct. 18, 2018 (JP) 2018-197049

(51) Int. Cl. F16H 61/70

(52) U.S. Cl. CPC F16H 61/702; F16D 21/00

(57) ABSTRACT

A control apparatus for a vehicle drive-force transmitting apparatus that defines (i) first drive-force transmitting path established by engagement of a first engagement device controlled by an on-off solenoid valve and (ii) a second drive-force transmitting path established by engagement of a second engagement device controlled by a linear solenoid valve. A third engagement device, which is, as well as the first engagement device, disposed in the first drive-force transmitting path, transmits a drive force during a driving state of the vehicle and cuts off transmission of the drive force during a driven state of the vehicle. When the first engagement device is to be placed into its engaged state during a neutral state of the drive-force transmitting apparatus, the first engagement device is engaged after the second engagement device is engaged, and the second engagement device is released upon completion of the engagement of the first engagement device.

This application claims priority from Japanese Patent Application No. 2018-197049 filed on Oct. 18, 2018, the disclosure of which is herein incorporated by reference in its entirety.

### FIELD OF THE INVENTION

The present invention relates to a control apparatus for a drive-force transmitting apparatus that is to be provided in a vehicle, wherein the drive-force transmitting apparatus defines a plurality of drive-force transmitting paths.

### BACKGROUND OF THE INVENTION

There is known a drive-force transmitting apparatus that is to be provided in a vehicle, wherein the drive-force transmitting apparatus defines a plurality of drive-force transmitting paths provided between an input shaft and an output shaft of the drive-force transmitting apparatus, and includes engagement devices configured to connect and disconnect the drive-force transmitting paths. As an example of such a drive-force transmitting apparatus, JP2015-113932A discloses a hybrid driving apparatus. In the hybrid driving apparatus disclosed in the Japanese Patent Application Publication, in a switching transition from one of the drive-force transmitting paths to another of the drive-force transmitting paths (in a process of a shifting action in the Japanese Patent Application Publication), a shock generated in the switching transition is minimized or reduced by a so-called “clutch-to-clutch control” that is executed for engaging an engagement device (that is to be engaged) while releasing another engagement device (that is to be released).

### SUMMARY OF THE INVENTION

By the way, for reducing the manufacturing cost, it might be possible to change a solenoid valve used for controlling a hydraulic pressure applied to at least one of engagement devices provided in the drive-force transmitting apparatus, from a linear solenoid valve to an on-off solenoid valve. However, where the hydraulic pressure applied to an engagement device is controlled by an on-off solenoid valve, the applied hydraulic pressure cannot be finely controlled. Therefore, for example, there is a risk of generation of a shock, in a case in which the vehicle is caused to run by engaging this engagement device (to which the hydraulic pressure controlled by an on-off solenoid valve is applied) from a neutral state of the drive-force transmitting apparatus, because the hydraulic pressure applied to this engagement device cannot be finely controlled.

The present invention was made in view of the background art described above. It is therefore an object of the present invention to provide a control apparatus for a drive-force transmitting apparatus that is to be provided in a vehicle, wherein the drive-force transmitting apparatus defines a plurality of drive-force transmitting paths, and includes engagement devices configured to connect and disconnect the drive-force transmitting paths, and wherein the control apparatus is capable of reducing a shock generated in process of engagement of at least one of the engagement devices, even where a hydraulic pressure applied to the at least one of the engagement devices is controlled by using an on-off solenoid valve.

The object indicated above is achieved according to the following aspects of the present invention.

According to a first aspect of the invention, there is provided a control apparatus for a drive-force transmitting apparatus that is to be provided in a vehicle, wherein the drive-force transmitting apparatus includes an input shaft, an output shaft and first, second and third engagement devices, and defines a plurality of drive-force transmitting paths that are provided between the input shaft and the output shaft, wherein the plurality of drive-force transmitting paths include a first drive-force transmitting path and a second drive-force transmitting path, such that the first drive-force transmitting path is provided with the first and third engagement devices, and such that the third engagement device is located between the first engagement device and the output shaft in the first drive-force transmitting path, wherein the first drive-force transmitting path is established by engagement of the first engagement device operated by a hydraulic pressure which is applied to the first engagement device and which is controlled by an on-off solenoid valve (that is a simple solenoid valve that is to be placed in either one of an open position and a closed position, without an operation position intermediate between the open and closed positions), such that a drive force is to be transmitted along the first drive-force transmitting path through the first and third engagement devices when the first drive-force transmitting path is established, wherein the second drive-force transmitting path is established by engagement of the second engagement device operated by a hydraulic pressure which is applied to the second engagement device and which is controlled by a linear solenoid valve, such that the drive force is to be transmitted along the second drive-force transmitting path through the second engagement device when the second drive-force transmitting path is established, wherein the third engagement device is configured to transmit the drive force during a driving state of the vehicle and to cut off transmission of the drive force during a driven state of the vehicle, and wherein said control apparatus comprises a transmission-shifting control portion configured, in a case in which the first engagement device is to be placed into an engaged state thereof during a neutral state of the drive-force transmitting apparatus, to cause the first engagement device to be engaged after causing the second engagement device to be engaged, and then to cause the second engagement device to be released upon completion of the engagement of the first engagement device. It is noted that the feature regarding to the third engagement device (which is described that the third engagement device is configured to transmit the drive force during a driving state of the vehicle and to cut off transmission of the drive force during a driven state of the vehicle) may be described alternatively that the third engagement device includes an input-side rotary portion and an output-side rotary portion such that rotation is to be transmitted between the input shaft and the input-side rotary portion along the first drive-force transmitting path and such that rotation is to be transmitted between the output-side rotary portion and the output shaft along the first drive-force transmitting path, wherein the input-side rotary portion is inhibited from being rotated in a predetermined one of opposite directions relative to the output-side rotary portion and is allowed to be rotated in the other of the opposite directions relative to the output-side rotary portion. Further, for example, the input-side rotary portion of the third engagement device is connected to a first rotary element and is to be rotated integrally with the first rotary element, wherein the output-side rotary portion of the third engagement device is connected to a second rotary element and is to be rotated integrally with the second rotary element, and wherein, when the first and second engagement devices are both engaged and the input shaft is rotated, the first and second rotary elements are both rotated such that a rotational speed of the second rotary element is higher than a rotational speed of the first rotary element, whereby the input-side rotary portion of the third engagement device is rotated in the other of the opposite directions relative to the output-side rotary portion of the third engagement device. It is further noted that the control apparatus may include an engagement determining portion configured to determine whether each of at least one of the first and second engagement devices is in the engaged state or not, depending on a rotational speed difference between rotational speeds of rotary elements that are located on respective front and rear sides of the each of the at least one of the first and second engagement devices in a corresponding one of the first and second drive-force transmitting paths, wherein said engagement determining portion is configured to determine that each of the at least one of the first and second engagement devices is in the engaged state, when the rotational speed difference is not larger than a determination threshold value.

According to a second aspect of the invention, in the control apparatus according to the first aspect of the invention, the first drive-force transmitting path provides a first gear ratio between the input and output shafts, and the second drive-force transmitting path provides a second gear ratio between the input and output shafts, such that the first gear ratio is higher than the second gear ratio.

According to a third aspect of the invention, in the control apparatus according to the first or second aspect of the invention, the transmission-shifting control portion is configured, upon the completion of the engagement of the first engagement device, to cause the hydraulic pressure applied to the second engagement device, to be reduced at a given rate.

According to a fourth aspect of the invention, in the control apparatus according to the first through third aspects of the invention, the drive-force transmitting apparatus further includes a continuously-variable transmission, wherein the first and second drive-force transmitting paths are provided in parallel with each other, and wherein the second drive-force transmitting path is provided with the continuously-variable transmission.

According to a fifth aspect of the invention, in the control apparatus according to the first through fourth aspects of the invention, the third engagement device is to be placed in a selected one of a one-way mode and a lock mode, such that the third engagement device is configured to transmit the drive force during the driving state of the vehicle and to cut off transmission of the drive force during the driven state of the vehicle when the third engagement device is placed in the one-way mode, and such that the third engagement device is configured to transmit the drive force during the driving state of the vehicle and during the driven state of the vehicle when the third engagement device is placed in the lock mode.

In the control apparatus according to the first aspect of the invention, when both of the first and second engagement devices are engaged, transmission of the drive force along the first drive-force transmitting path is cut off by the third engagement device. Thus, when the first engagement device is engaged after the second engagement device is engaged, the first drive-force transmitting path is disconnected by the third engagement device, so that the first and second engagement devices can be both placed in the engaged states. Therefore, in the case in which the first engagement device is to be placed into the engaged state thereof during the neutral state of the drive-force transmitting apparatus, the second engagement device is first engaged to establish the second drive-force transmitting path (namely, to place the second drive-force transmitting path in a drive-force transmittable state), and then the first engagement device is engaged after the second engagement device is engaged, whereby a shock generated in process of engagement of the first engagement device can be reduced although the hydraulic pressure applied to the first engagement device cannot be finely controlled. Further, when the engagement of the first engagement device is completed, the second engagement device is released so as to establish the first drive-force transmitting path (namely, to place the first drive-force transmitting path in a drive-force transmittable state), whereby the vehicle is enabled to run with the drive force being transmitted along the first drive-force transmitting path.

In the control apparatus according to the second aspect of the invention, the first drive-force transmitting path provides the first gear ratio between the input and output shafts, and the second drive-force transmitting path provides the second gear ratio between the input and output shafts, such that the first gear ratio is higher than the second gear ratio. Thus, when the first and second engagement devices are both engaged, the first drive-force transmitting path is disconnected by the third engagement device, so that the first and second drive-force transmitting paths are avoided from interfering with each other in transmission of the drive force.

In the control apparatus according to the third aspect of the invention, when the engagement of the first engagement device is completed, the hydraulic pressure applied to the second engagement device is reduced at the given rate. Thus, a shock generated in process of release of the second engagement device is reduced.

In the control apparatus according to the fourth aspect of the invention, when the second drive-force transmitting path is established to be placed in the drive-force transmittable state, the vehicle is enabled to run with a shifting action being executed as needed in the continuously variable transmission that is provided in the second drive-force transmitting path.

In the control apparatus according to the fifth aspect of the invention, the third engagement device is to be placed in a selected one of the one-way mode and the lock mode. Therefore, for example, when the vehicle is caused to run by an inertia with the first drive-force transmitting path being established to be placed in a drive-force transmittable state, the third engagement device is placed in the lock mode, thereby enabling an engine brake to be generated by drag of a drive force source that is caused by rotation of drive wheels transmitted to the drive force source through the third engagement device that is placed in the lock mode.

### BRIEF DESCRIPTION OF THE DRAWINGS

FIG. 1 is a schematic view showing a construction of a vehicle to be controlled by an electronic control apparatus according to an embodiment of the present invention, and major control functions and control portions of the control apparatus;

FIG. 2 is a view schematically showing a construction of a two-way clutch shown in FIG. 1, wherein the view is a cross sectional view of a circumferential portion of the two-way clutch, taken in a plane perpendicular to a radial direction of the two-way clutch, and shows the two-way clutch in its one-way mode;

FIG. 3 is a view schematically showing the construction of the two-way clutch shown in FIG. 1, wherein the view is the cross sectional view of the circumferential portion, taken in the plane perpendicular to the radial direction of the two-way clutch, and shows the two-way clutch in its lock mode;

FIG. 4 is a table indicating an operation state of each of engagement devices for each of operation positions which is selected by operation of a manually-operated shifting device in the form of a shift lever that is provided in the vehicle;

FIG. 5 is a view schematically showing a hydraulic control unit configured to control operation states of a continuously variable transmission and a drive-force transmitting apparatus shown in FIG. 1;

FIG. 6 is a flow chart showing a main part of a control routine executed by the electronic control apparatus shown in FIG. 1, namely, a control routine that is executed when an operation position of the shift lever has been switched from its neutral position N to its drive position D while the vehicle is stopped or running at a low running speed;

FIG. 7 is a time chart showing a result of the control routine that is executed as shown in the flow chart of FIG. 6, specifically, a result of the control routine that is executed when the operation position of the shift lever has been switched from its neutral position N to its drive position D;

FIG. 8 is a schematic view showing a construction of a vehicle to be controlled by an electronic control apparatus according to another embodiment of the present invention, and major control functions and control portions of the control apparatus;

FIG. 9 is a flow chart showing a main part of a control routine executed by the electronic control apparatus shown in FIG. 8, namely, a control routine that is executed when the vehicle is to be returned from a N control to a gear running mode so as to run in the gear running mode; and

FIG. 10 is a time chart showing a result of the control routine that is executed as shown in the flow chart of FIG. 9, specifically, a result of the control routine that is executed when the vehicle is to be switched back from the N control to the gear running mode.

### DETAILED DESCRIPTION OF PREFERRED EMBODIMENTS

Hereinafter, preferred embodiments of the invention will be described in detail with reference to the accompanying drawings. The figures of the drawings are simplified or deformed as needed, and each portion is not necessarily precisely depicted in terms of dimension ratio, shape, etc.

### First Embodiment

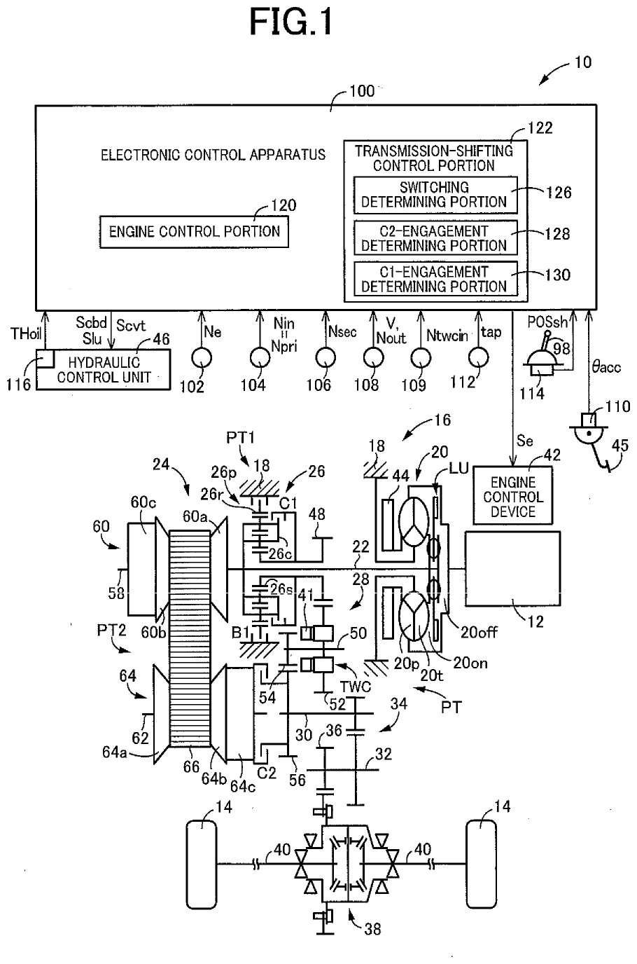

FIG. 1 is a schematic view showing a construction of a vehicle 10 to be controlled by a control apparatus according to the present invention. As shown in FIG. 1, the vehicle 10 is provided with an engine 12 functioning as a drive force source configured to generate a drive force, drive wheels 14 and a vehicle drive-force transmitting apparatus 16 that is configured to transmit the drive force of the engine 12 to the drive wheels 14.

The drive-force transmitting apparatus 16 includes a non-rotary member in the form of a casing 18, a fluid-operated type drive-force transmitting device in the form of a known torque converter 20 that is connected to the engine 12, an input shaft 22 connected to the torque converter 20, a belt-type continuously variable transmission 24 connected to the input shaft 22, a forward/reverse switching device 26 connected to the input shaft 22, a gear mechanism 28 which is provided in parallel with the continuously variable transmission 24 and which is connected to the input shaft 22 via the forward/reverse switching device 26, an output shaft 30 serving as an output rotary member that is common to the continuously variable transmission 24 and the gear mechanism 28, a counter shaft 32, a reduction gear device 34 consisting of a pair of mutually meshing gears each of which is connected to a corresponding one of the output shaft 30 and the counter shaft 32 so as to unrotatable relative to the corresponding one of the shafts 30, 32, a gear 36 connected to the counter shaft 32 so as to be unrotatable relative to the counter shaft 32, a differential gear device 38 connected to the gear 36 in a drive-force transmittable manner, and right and left axles 40 that connect the differential gear device 38 to the respective right and left drive wheels 14. The torque converter 20, input shaft 22, continuously variable transmission 24, forward/reverse switching device 26, gear mechanism 28, output shaft 30, counter shaft 32, reduction gear device 34, gear 36 and differential gear device 38 are disposed within the casing 18.

In the drive-force transmitting apparatus 16 constructed as described above, the drive force generated by the engine 12 is transmitted to the right and left drive wheels 14, via the torque converter 20, forward/reverse switching device 26, gear mechanism 28, reduction gear device 34, differential gear device 38, axles 40 and other elements, or alternatively, via the torque converter 20, continuously variable transmission 24, reduction gear device 34, differential gear device 38, axles 40 and other elements. It is noted that the above-described drive force is synonymous with a drive torque or a drive power unless otherwise distinguished from them.

The drive-force transmitting apparatus 16 defines a first drive-force transmitting path PT1 and a second drive-force transmitting path PT2 that are provided in parallel with each other between the input shaft 22 and the output shaft 30, such that the drive force of the engine 12 is to be transmitted along a selected one of the first and second drive-force transmitting paths PT1, PT2 from the input shaft 22 to the output shaft 30. The first drive-force transmitting path PT1 is provided with the gear mechanism 28 while the second drive-force transmitting path PT2 is provided with the continuously variable transmission 24. Thus, the drive-force transmitting apparatus 16 has a plurality of drive-force transmitting paths in the form of the first and second drive-force transmitting paths PT1, PT2, which are provided in parallel with each other between the input shaft 22 and the output shaft 30.

The first drive-force transmitting path PT1 is provided with: the forward/reverse switching device 26 including a first clutch C1 and a first brake B1; the gear mechanism 28; and a two-way clutch TWC serving as a third engagement device, and is a drive-force transmitting path along which the drive force of the engine 12 is to be transmitted from the input shaft 22 to the drive wheels 14 through the gear mechanism 28. In the first drive-force transmitting path PT1, the forward/reverse switching device 26, gear mechanism 28 and two-way clutch TWC are arranged in this order of description in a direction away from the engine 12 toward the drive wheels 14, so that the two-way clutch TWC is provided between the first clutch C1 (that is included in the forward/reverse switching device 26) the output shaft 30 in the first drive-force transmitting path PT1. It is noted that the two-way clutch TWC corresponds to “third engagement device” recited in the appended claims.

The second drive-force transmitting path PT2 is provided with the continuously variable transmission 24 and a second clutch C2, and is a drive-force transmitting path along which the drive force of the engine 12 is to be transmitted from the input shaft 22 to the drive wheels 14 through the continuously variable transmission 24. In the second drive-force transmitting path PT2, the continuously variable transmission 24 and second clutch C2 are arranged in this order of description in a direction away from the engine 12 toward the drive wheels 14.

The continuously variable transmission 24, which is provided in the second drive-force transmitting path PT2, includes a primary shaft 58 provided to be coaxial with the input shaft 22 and connected integrally to the input shaft 22, a primary pulley 60 connected to the primary shaft 58 and having a variable effective diameter, a secondary shaft 62 provided to be coaxial with the output shaft 30, a secondary pulley 64 connected to the secondary shaft 62 and having a variable effective diameter, and a transfer element in the form of a transmission belt 66 looped over or mounted on the pulleys 60, 64. The continuously variable transmission 24 is a known belt-type continuously-variable transmission in which the drive force is transmitted owing to a friction force generated between the transmission belt 66 and each of the pulleys 60, 64, and is configured to transmit the drive force of the engine 12 toward the drive wheels 14.

The gear mechanism 28, which is provided in the first drive-force transmitting path PT1, provides a gear ratio EL (=input-shaft rotational speed Nin/output-shaft rotational speed Nout) between the input and output shafts 22, 30 in the first drive-force transmitting path PT1. The gear ratio EL is higher than a highest gear ratio between the input and output shafts 22, 30 in the second drive-force transmitting path PT2, which corresponds to a highest gear ratio γmax of the continuously variable transmission 24. That is, the gear ratio EL of the gear mechanism 28, which may be interpreted also as a gear ratio in the first drive-force transmitting path PT1, is set to be a gear ratio that provides a lower speed than the highest gear ratio γmax, so that a gear ratio established between the input and output shafts 22, 30 in the second drive-force transmitting path PT2 provides a higher speed than the gear ratio EL established between the input and output shafts 22, 30 in the first drive-force transmitting path PT1. It is noted that the input-shaft rotational speed Nin is a rotational speed of the input shaft 22 and that the output-shaft rotational speed Nout is a rotational speed of the output shaft 30. It is further noted that the gear ratio EL corresponds to “first gear ratio” recited in the appended claims, and that the highest gear ratio γmax of the continuously variable transmission 24 corresponds to “second gear ratio” recited in the appended claims.

In the drive-force transmitting apparatus 16, one of the first and second drive-force transmitting paths PT1, PT2, which is selected depending on a running state of the vehicle 10, is established, and the drive force of the engine 12 is transmitted to the drive wheels 14 along the established one of the first and second drive-force transmitting paths PT1, PT2. Therefore, the drive-force transmitting apparatus 16 includes a plurality of engagement devices for selectively establishing the first and second drive-force transmitting paths PT1, PT2. The plurality of engagement devices include the above-described first clutch C1, first brake B1, second clutch C2 and two-way clutch TWC.

The first clutch C1, which is provided in the first drive-force transmitting path PT1, is an engagement device which is configured to selectively connect and disconnect the first drive-force transmitting path PT1, and which is configured, when the vehicle 10 is to run in forward direction, to enable the drive force to be transmitted along the first drive-force transmitting path PT1, by being engaged. The first brake B1, which is also provided in the first drive-force transmitting path PT1, is an engagement device which is configured to selectively connect and disconnect the first drive-force transmitting path PT1, and which is configured, when the vehicle 10 is to run in reverse direction, to enable the drive force to be transmitted along the first drive-force transmitting path PT1 by being engaged. The first drive-force transmitting path PT1 is established by engagement of either the first clutch C1 or the first brake B1. It is noted that the first clutch C1 corresponds to “first engagement device” recited in the appended claims.

The second clutch C2, which is provided in the second drive-force transmitting path PT2, is an engagement device which is configured to selectively connect and disconnect the second drive-force transmitting path PT2, and which is configured, when the vehicle 10 is to run in forward direction, to enable the drive force to be transmitted along the second drive-force transmitting path PT2, by being engaged. It is noted that the second clutch C2 corresponds to “second engagement device” recited in the appended claims.

Each of the first clutch C1, first brake 131 and second clutch C2 is a known hydraulically-operated wet-type frictional engagement device that is to be frictionally engaged by operation of a hydraulic actuator. Each of the first clutch C1 and first brake B1 constitutes a part of the forward/reverse switching device 26.

The two-way clutch TWC, which is also provided in the first drive-force transmitting path PT1, is to be placed in a selected one of a one-way mode and a lock mode, such that the two-way clutch TWC is configured to transmit the drive force during a driving state of the vehicle 10 in the forward running and to cut off transmission of the drive force during a driven state of the vehicle 10 in the forward running when the two-way clutch TWC is placed in the one-way mode, and such that the two-way clutch TWC is configured to transmit the drive force during the driving state of the vehicle 10 and during the driven state of the vehicle 10 when the two-way clutch TWC is placed in the lock mode. For example, with the first clutch C1 being placed in the engaged state and with the two-way clutch TWC being placed in the one-way mode, the drive force is transmittable along the first drive-force transmitting path PT1 during the driving state of the vehicle 10 during which the vehicle 10 runs in forward direction by the drive force of the engine 12. That is, during the forward running of the vehicle 10, the drive force of the engine 12 is transmitted to the drive wheels 14 along the first drive-force transmitting path PT1. On the other hand, during the driven state of the vehicle 10, for example, during an inertia running of the vehicle 10 in forward direction, rotation transmitted from the drive wheels 14 is blocked by the of the two-way clutch TWC even when the first clutch C1 is in the engaged state. It is noted that the driving state of the vehicle 10 is a state in which a torque applied to the input shaft 22 takes a positive value so as to act on the input shaft 22 in a direction corresponding to a direction of the running of the vehicle 10, namely, practically, a state in which the vehicle 10 is driven by the drive force of the engine 12. It is further noted that the driven state of the vehicle 10 is a state in which a torque applied to the input shaft 22 takes a negative value so as to act on the input shaft 22 in a direction opposite to a direction of the running of the vehicle 10, namely, practically, a state in which the vehicle 10 is caused to run by an inertia with the engine 12 being dragged by rotation transmitted from the drive wheels 14.

Further, in a state in which the two-way clutch TWC is in the lock mode with the first clutch C1 being in the engaged state, the drive force is enabled to be transmitted through the two-way clutch TWC during the driven state of the vehicle 10 as well as during the driving state of the vehicle 10. In this state, the drive force of the engine 12 is transmitted to the drive wheels 14 along the first drive-force transmitting path PT1, and, during the driven state of the vehicle 10 such as the inertia running, the rotation transmitted from the drive wheels 14 is transmitted to engine 12 along the first drive-force transmitting path PT1 whereby the engine 12 is dragged to generate an engine brake. Further, in a state in which the two-way clutch TWC is in the lock mode with the first brake B1 being in the engaged state, the drive force of the engine 12 is transmitted to the drive wheels 14 through the two-way clutch TWC along the first drive-force transmitting path PT1 and acts on the drive wheels 14 so as to force the drive wheels 14 to be rotated in a direction that causes the vehicle 10 to run in reverse direction. Thus, in this state, the vehicle 10 is enabled to run in the reverse direction with the drive force transmitted along the transmitting path PT1 to the drive wheels 14. The construction of the two-way clutch TWC will be described later.

The engine 12 is provided with an engine control device 42 including an electronic throttle device, a fuel injection device, an ignition device and other devices that are required for controlling an output of the engine 12. In the engine 12, the engine control device 42 is controlled, by an electronic control apparatus 100 (that corresponds to “control apparatus” recited in the appended claims), based on an operation amount θacc of an accelerator pedal 45 that corresponds to a required drive force of the vehicle 10 required by an operator of the vehicle 10, whereby an engine torque Te as an output torque of the engine 12 is controlled.

The torque converter 20 is provided between the engine 12 and the continuously variable transmission 24, and includes a pump impeller 20p and a turbine impeller 20t, such that the pump impeller 20p is connected to the engine 12 while the turbine impeller 20t is connected to the input shaft 22. The torque converter 20 is a fluid-operated type drive-force transmitting device configured to transmit the drive force of the engine 12 to the input shaft 22. The torque converter 20 is provided with a known lock-up clutch LU disposed between the pump impeller 20p and the turbine impeller 20t that serve as an input rotary member and an output rotary member of the torque converter 20, respectively, so that the pump impeller 20p and the turbine impeller 20t, namely, the engine 12 and the input shaft 22, can be directly connected to each other through the lock-up clutch LU, depending on the running state of the vehicle 10. The engine 12 and the input shaft 22 are directly connected to each other through the lock-up clutch LU, for example, when the vehicle 10 runs at a speed within a relatively high speed range.

The drive-force transmitting apparatus 16 is provided with a mechanical oil pump 44 connected to the pump impeller 20p. The oil pump 44 is to be driven by the engine 12, to supply a working fluid pressure as its original pressure to a hydraulic control unit (hydraulic control circuit) 46 (see FIG. 5) that is provided in the vehicle 10, for performing a shifting control operation in the continuously-variable transmission 24, generating a belt clamping force in the continuously-variable transmission 24, switching the operation state of the lock-up clutch LU and switching the operation state of each of the above-described engagement devices between its engaged state and released state, or between its one-way mode and lock mode.

The forward/reverse switching device 26 includes a planetary gear device 26p of double-pinion type in addition to the first clutch C1 and the first brake B1. The planetary gear device 26p is a differential mechanism including three rotary elements consisting of an input element in the form of a carrier 26c, an output element in the form of a sun gear 26s and a reaction element in the form of a ring gear 26r. The carrier 26c is connected to the input shaft 22. The ring gear 26r is operatively connected to the casing 18 through the first brake B1. The sun gear 26s is disposed radially outside the input shaft 22, and is connected to a small-diameter gear 48 that is rotatable relative to the input shaft 22. The carrier 26c and the sun gear 26s are operatively connected to each other through the first clutch C1.

The gear mechanism 28 includes, in addition to the above-described small-diameter gear 48, a gear-mechanism counter shaft 50 and a large-diameter gear 52 which meshes with the small-diameter gear 48 and which is mounted on the counter shaft 50, rotatably relative to the counter shaft 50. The gear mechanism 28 further includes a counter gear 54 and an output gear 56. The counter gear 54 is mounted on the counter shaft 50, unrotatably relative to the counter shaft 50, and meshes with the output gear 56 that is mounted on the output shaft 30. It is noted that the large-diameter gear 52 and the counter gear 54 correspond to “first and second rotary elements”, respectively, which are recited in the appended claims.

The two-way clutch TWC is provided between the large-diameter gear 52 and the counter gear 54 in an axial direction of the counter shaft 50, so as to selectively connect and disconnect the large-diameter gear 52 to and from the counter gear 54, such that the two-way clutch TWC is located to be closer, than the first clutch C1 and the gear mechanism 28, to the drive wheels 14 in the first drive-force transmitting path PT1. That is, the two-way clutch TWC is located between the first clutch C1 (and the gear mechanism 28) and the output shaft 30 in the first drive-force transmitting path PT1. The two-way clutch TWC is switchable between the one-way mode and the lock mode by operation of a hydraulic actuator 41 that is disposed to be adjacent to the two-way clutch TWC in the axial direction of the counter shaft 50, so as to be placed in a selected one of the one-way mode and the lock mode.

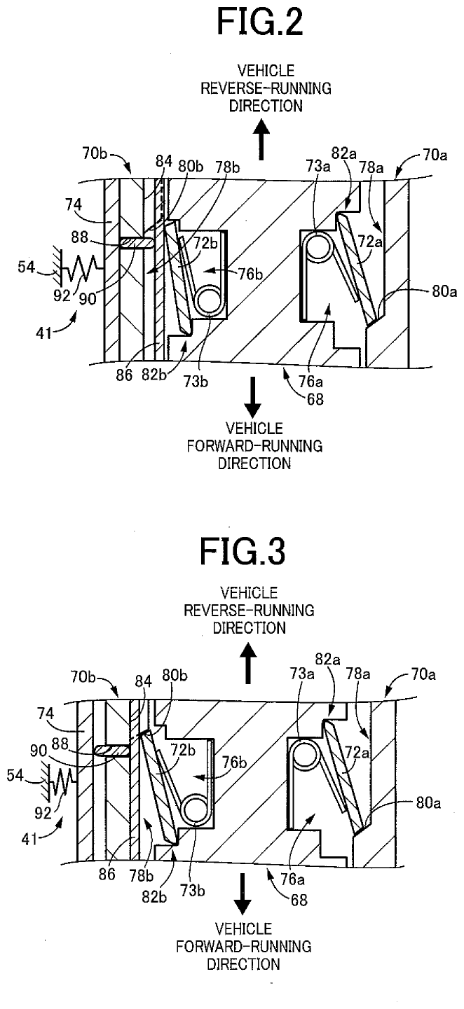

Each of FIGS. 2 and 3 is a view schematically showing a construction of the two-way clutch TWC, which enables switching between the one-way mode and the lock mode, wherein the view is a cross sectional view of a circumferential portion of the two-way clutch, taken in a plane perpendicular to a radial direction of the two-way clutch TWC. FIG. 2 shows a state in which the two-way clutch TWC is placed in the one-way mode. FIG. 3 shows a state in which the two-way clutch TWC is placed in the lock mode. In each of FIGS. 2 and 3; a vertical direction on the drawing sheet corresponds to a circumferential direction of the two-way clutch TWC, an upward direction on the drawing sheet corresponds to a vehicle reverse-running direction (i.e., direction of rotation for reverse running of the vehicle 10) and a downward direction on the drawing sheet corresponds to a vehicle forward-running direction (i.e., direction of rotation for forward running of the vehicle 10). Further, in each of FIGS. 2 and 3, a horizontal direction on the drawing sheet corresponds to the axial direction of the counter shaft 50 (hereinafter, the term “axial direction” means the axial direction of the counter shaft 50 unless otherwise specified), a rightward direction on the drawing sheet corresponds to a direction toward the large-diameter gear 52 shown in FIG. 1, and a leftward direction on the drawing sheet corresponds to a direction toward the counter gear 54 shown in FIG. 1.

The two-way clutch TWC has generally a disk shape, and is disposed radially outside the counter shaft 50. The two-way clutch TWC includes an input-side rotary member 68, first and second output-side rotary members 70a, 70b that are disposed to be adjacent to the input-side rotary member 68 so as to be located on respective opposite sides of the input-side rotary member 68 in the axial direction, a plurality of first struts 72a and a plurality of torsion coil springs 73a that are interposed between the input-side rotary member 68 and the first output-side rotary member 70a in the axial direction, and a plurality of second struts 72b and a plurality of torsion coil springs 73b that are interposed between the input-side rotary member 68 and the second output-side rotary member 70b in the axial direction. It is noted that the input-side rotary member 68 constitutes “input-side rotary portion (of the two-way clutch)” recited in the appended claims, and that the first and second output-side rotary members 70a, 70b cooperate with each other to constitute “output-side rotary portion (of the two-way clutch)” recited in the appended claims.

The input-side rotary member 68 has generally a disk shape, and is rotatable relative to the counter shaft 50 about an axis of the counter shaft 50. The input-side rotary member 68 is located between the first and second output-side rotary members 70a, 70b (hereinafter referred to as output-side rotary members 70 when they are not to be particularly distinguished from each other) in the axial direction. The input-side rotary member 68 is formed integrally with the large-diameter gear 52, such that teeth of the larger-diameter gear 52 are located radially outside the input-side rotary member 68. The input-side rotary member 68 is connected to the engine 12, in a drive-force transmittable manner, through the gear mechanism 28 and the forward/reverse switching device 26, for example.

The input-side rotary member 68 has, in its axial end surface that is opposed to the first output-side rotary member 70a in the axial direction, a plurality of first receiving portions 76a in which the first struts 72a and the torsion coil springs 73a are received. The first receiving portions 76a are equi-angularly spaced apart from each other in a circumferential direction of the input-side rotary member 68. Further, the input-side rotary member 68 has, in another axial end surface thereof that is opposed to the second output-side rotary member 70b in the axial direction, a plurality of second receiving portions 76b in which the second struts 72b and the torsion coil springs 73b are received. The second receiving portions 76b are equi-angularly spaced apart from each other in the circumferential direction of the input-side rotary member 68. The first and second receiving portions 76a are substantially aligned in a radial direction of the input-side rotary member 68.

The first output-side rotary member 70a has generally a disk-shaped, and is rotatable about the axis of the counter shaft 50. The first output-side rotary member 70a is unrotatable relative to the counter shaft 50, so as to be rotated integrally with the counter shaft 50. The first output-side rotary member 70a is connected to the drive wheels 14, in a drive-force transmittable manner, through the counter shaft 50, counter gear 54 output shaft 30 and differential gear device 38, for example.

The first output-side rotary member 70a has, in its surface that is opposed to the input-side rotary member 68 in the axial direction, a plurality of first recessed portions 78a each of which is recessed in a direction away from the input-side rotary member 68. The first recessed portions 78a, whose number is the same as the first receiving portions 76a, are equi-angularly spaced apart from each other in the circumferential direction. The first recessed portions 78a are substantially aligned with the first receiving portions 76a provided in the input-side rotary member 68, in a radial direction of the first output-side rotary member 70a. Therefore, when each of the first receiving portions 76a is aligned with one of the first recessed portions 78a in the circumferential direction, namely, when a rotational position of each of the first receiving portions 76a coincides with that of one of the first recessed portions 78a, the first receiving portion 76a and the first recessed portion 78a are opposed to and adjacent with each other in the axial direction. Each of the first recessed portions 78a has a shape by which a longitudinal end portion of any one of the first struts 72a can be received in the first recessed portion 78a. Further, each of the first recessed portions 78a has, in its circumferential end, a first wall surface 80a with which the longitudinal end portion of one of the first struts 72a is to be in contact, when the input-side rotary member 68 is rotated in the above-described vehicle forward-running direction (corresponding to the downward direction on the drawing sheet of each of FIGS. 2 and 3) relative to the output-side rotary members 70, by the drive force of the engine 12.

The second output-side rotary member 70b has generally a disk-shaped, and is rotatable about the axis of the counter shaft 50. The second output-side rotary member 70b is unrotatable relative to the counter shaft 50, so as to be rotated integrally with the counter shaft 50. The second output-side rotary member 70b is connected to the drive wheels 14, in a drive-force transmittable manner, through the counter shaft 50, counter gear 54, output shaft 30 and differential gear device 38, for example.

The second output-side rotary member 70b has, in its surface that is opposed to the input-side rotary member 68 in the axial direction, a plurality of second recessed portions 78b each of which is recessed in a direction away from the input-side rotary member 68. The second recessed portions 78b, whose number is the same as the second receiving portions 76b, are equi-angularly spaced apart from each other in the circumferential direction. The second recessed portions 78b are substantially aligned with the second receiving portions 76b provided in the input-side rotary member 68, in a radial direction of the second output-side rotary member 70b. Therefore, when each of the second receiving portions 76b is aligned with one of the second recessed portions 78b in the circumferential direction, namely, when a rotational position of each of the second receiving portions 76b coincides with that of one of the second recessed portions 78b, the second receiving portion 76b and the second recessed portion 78b are opposed to and adjacent with each other in the axial direction. Each of the second recessed portions 78b has a shape by which a longitudinal end portion of any one of the second struts 72b can be received in the second recessed portion 78b. Further, each of the second recessed portions 78b has, in its circumferential end, a second wall surface 80b with which the longitudinal end portion of one of the second struts 72b is to be in contact, when the input-side rotary member 68 is rotated in the above-described vehicle reverse-running direction (corresponding to the upward direction on the drawing sheet of each of FIGS. 2 and 3) relative to the output-side rotary members 70, by the drive force of the engine 12 with the two-way clutch TWC being placed in the lock mode, or when the vehicle 10 is in an inertia running state during the forward running with the two-way clutch TWC being placed in the lock mode.

Each of the first struts 72a is constituted by a plate-like member having a predetermined thickness, and is elongated in the circumferential direction (corresponding to the vertical direction on the drawing sheet), as shown in the cross sectional views of FIGS. 2 and 3. Further, each of the first struts 72a has a predetermined dimension as measured in a direction perpendicular to the drawing sheet of FIGS. 2 and 3.

The longitudinal end portion of each of the first struts 72a is constantly forced or biased, by a corresponding one of the torsion coil springs 73a, toward the first output side rotary member 70a. Further, each of the first struts 72a is in contact at another longitudinal end portion thereof with a first stepped portion 82a provided in a corresponding one of the first receiving portions 76a, such that the first strut 72a is pivotable about the other longitudinal end portion thereof that is in contact with the first stepped portion 82a. Each of the torsion coil springs 73a is interposed between a corresponding one of the first struts 72a and the input-side rotary member 68, and constantly forces or biases the longitudinal end portion of the corresponding one of the first struts 72a toward the first output-side rotary member 70a.

Owing to the above-described construction, in a state in which the two-way clutch TWC is placed in either the one-way mode or the lock mode, when the input-side rotary member 68 receives the drive force which is transmitted from the engine 12 and which acts in the vehicle forward-running direction, each of the first struts 72a is in contact at the longitudinal end portion with the first wall surface 80a of the first output-side rotary member 70a and is in contact at the other longitudinal end portion with the first stepped portion 82a of the input-side rotary member 68, so that the input-side rotary member 68 and the first output-side rotary member 70a are inhibited from being rotated relative to each other whereby the drive force acting in the vehicle forward-running direction is transmitted to the drive wheels 14 through the two-way clutch TWC. The above-described first struts 72a, torsion coil springs 73a, first receiving portions 76a and first recessed portions 78a (each defining the first wall surface 80a) cooperate to constitute a one-way clutch that is configured to transmit the drive force during the driving state in the forward running of the vehicle 10, and to cut off transmission of the drive force during the driven state in the forward running of the vehicle 10. The one-way clutch practically constitutes the “third engagement device” recited in the appended claims.

Each of the second struts 72b is constituted by a plate-like member having a predetermined thickness, and is elongated in the circumferential direction (corresponding to the vertical direction on the drawing sheet), as shown in the cross sectional views of FIGS. 2 and 3. Further, each of the second struts 72b has a predetermined dimension as measured in a direction perpendicular to the drawing sheet of FIGS. 2 and 3.

The longitudinal end portion of each of the second struts 72b is constantly forced or biased, by a corresponding one of the torsion coil springs 73b, toward the second output-side rotary member 70b. Further, each of the second struts 72b is in contact at another longitudinal end portion thereof with a second stepped portion 82b provided in one of the second receiving portions 76b, such that the second strut 72b is pivotable about the other longitudinal end portion thereof that is in contact with the second stepped portion 82b. Each of the torsion coil springs 73b is interposed between a corresponding one of the second struts 72b and the input-side rotary member 68, and constantly forces or biases the longitudinal end portion of the corresponding one of the second struts 72b toward the second output-side rotary member 70b.

Owing to the above-described construction, in a state in which the two-way clutch TWC is placed in the lock mode, when the input-side rotary member 68 receives the drive force which is transmitted from the engine 12 and which acts in the vehicle reverse-running direction, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the drive force acting in the vehicle reverse-running direction is transmitted to the drive wheels 14 through the two-way clutch TWC. Further, in the state in which the two-way clutch TWC is placed in the lock mode, when the inertia running is made during running of the vehicle 10 in the forward direction, too, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the rotation transmitted from the drive wheels 14 is transmitted toward the engine 12 through the two-way clutch TWC. The above-described second struts 72b, torsion coil springs 73b, second receiving portions 76b and second recessed portions 78b (each defining the second wall surface 80b) cooperate to constitute a one-way clutch that is configured to transmit the drive force acting in the vehicle reverse-running direction, toward the drive wheels 14, and to cut off transmission of the drive force acting in the vehicle forward-running direction, toward the drive wheels 14.

Further, the second output-side rotary member 70b has a plurality of through-holes 88 that pass through the second output-side rotary member 70b in the axial direction. Each of the through-holes 88 is located in a position that overlaps with a corresponding one of the second recessed portions 78b in the axial direction of the counter shaft 50, so that each of the through-holes 88 is in communication at its end with a corresponding one of the second recessed portions 78b. A cylindrical-shaped pin 90 is received in each of the through-holes 88, and is slidable in the through-hole 88. The pin 90 is in contact at one of its axially opposite ends with a pressing plate 74 that constitutes a part of the hydraulic actuator 41, and is in contact at the other of its axially opposite ends with an annular ring 86 that includes a plurality of portions that are located in the respective second recessed portions 78b in the circumferential direction.

The ring 86 is fitted in a plurality of arcuate-shaped grooves 84, each of which is provided in the second output-side rotary member 70b and interconnects between a corresponding adjacent pair of the second recessed portions 78b that are adjacent to each other in the circumferential direction. The ring 86 is movable relative to the second output-side rotary member 70b in the axial direction.

Like the two-way clutch TWC, the hydraulic actuator 41 is disposed on the counter shaft 50, and is located in a position adjacent to the second output-side rotary member 70b in the axial direction of the counter shaft 50. The hydraulic actuator 41 includes, in addition to the pressing plate 74, a plurality of coil springs 92 that are interposed between the counter gear 54 and the pressing plate 74 in the axial direction, and a hydraulic chamber (not shown) to which a working fluid is to be supplied whereby a thrust is generated to move the pressing plate 74 toward the counter gear 54 in the axial direction.

The pressing plate 74 has generally a disk shape, and is disposed to be movable relative to the counter shaft 50 in the axial direction. The pressing plate 74 is constantly forced or biased by the spring 92 toward the second output-side rotary member 70b in the axial direction. Therefore, in a state in which the working fluid is not supplied to the above-described hydraulic chamber of the hydraulic actuator 41, the pressing plate 74 is moved, by biasing force of the spring 92, toward the second output-side rotary member 70b in the axial direction, whereby the pressing plate 74 is in contact with the second output-side rotary member 70b, as shown in FIG. 2. In this state, the pins 90, the ring 86 and the longitudinal end portion of each of the second struts 72b are moved toward the input-side rotary member 68 in the axial direction, as shown in FIG. 2, whereby the two-way clutch TWC is placed in the one-way mode.

In a state in which the working fluid is supplied to the above-described hydraulic chamber of the hydraulic actuator 41, the pressing member 74 is moved, against the biasing force of the spring 90, toward the counter gear 54 in the axial direction, so as to be separated from the second output-side rotary member 70b. In this state, the pins 90, the ring 86 and the longitudinal end portion of each of the second struts 72b are moved, by the biasing force of the torsion coil springs 73b, toward the counter gear 54 in the axial direction, as shown in FIG. 3, whereby the two-way clutch TWC is placed in the lock mode.

In the state in which the two-way clutch TWC is placed in the one-way mode, as shown in FIG. 2, the pressing plate 74 is in contact with the second output-side rotary member 70b by the biasing force of the spring 92. In this state, the pins 90 are forced, by the pressing plate 74, to be moved toward the input-side rotary member 68 in the axial direction, and the ring 86 is forced, by the pins 90, to be moved toward the input-side rotary member 68 in the axial direction. Consequently, the longitudinal end portion of each of the second struts 72b is forced, by the ring 86, to be moved toward the input-side rotary member 68, so as to be blocked from being in contact with the second wall surface 80b, whereby the input-side rotary member 68 and the second output-side rotary member 70b are allowed to be rotated relative to each other so that the second struts 72b do not serve as a one-way clutch. Meanwhile, the longitudinal end portion of each of the first struts 72a is biased, by the corresponding coil spring 73a, toward the first output-side rotary member 70a, whereby the longitudinal end portion of each of the first struts 72a can be bought into contact with the first wall surface 80a of any one of the first recessed portions 78a so that the first struts 72a serve as a one-way clutch configured to transmit the drive force acting in the vehicle forward-running direction. That is, the first struts 72a serve as the one-way clutch that is configured to transmit the drive force during the driving state in the forward running of the vehicle 10, and to cut off transmission of the drive force during the driven state in the forward running of the vehicle 10.

In the state in which the two-way clutch TWC is placed in the one-way mode, as shown in FIG. 2, the longitudinal end portion of each of the first struts 72a can be brought into contact with the first wall surface 80a of the first output-side rotary member 70a. Therefore, in the state of the one-way mode of the two-way clutch TWC, when the vehicle 10 is placed in the driving state in which the drive force acting in the vehicle forward-running direction is transmitted from the engine 12 to the two-way clutch TWC, the longitudinal end portion of each of the first struts 72a is in contact with the first wall surface 80a and the other longitudinal end portion of each of the first struts 72a is in contact with the first stepped portion 82a, so that the input-side rotary member 68 is inhibited from being rotated relative to the first output-side rotary member 70a in the vehicle forward-running direction whereby the drive force of the engine 12 is transmitted to the drive wheels 14 through the two-way clutch TWC. On the other hand, in the state of the one-way mode of the two-way clutch TWC, when the vehicle 10 is placed in the driven state by inertia running during the forward running, the input-side rotary member 68 is allowed to be rotated relative to the first output-side rotary member 70a in the vehicle reverse-running direction, without the longitudinal end portion of each of the first struts 72a being in contact with the first wall surface 80a, whereby the transmission of the drive force through the two-way clutch TWC is blocked. Thus, in the state in which the two-way clutch TWC is placed in the one-way mode, the first struts 72a serve as the one-way clutch which is configured to transmit the drive force in the driving state of the vehicle 10 in which the drive force acting in the vehicle forward-running direction is transmitted from the engine 12, and which is configured to block transmission of the drive force in the driven state of the vehicle 10 which is placed by inertia running during the forward running. In other words, the input-side rotary member 68 as the input-side rotary portion is inhibited from being rotated in the vehicle forward-running direction (as a predetermined one of opposite directions) relative to the output-side rotary members 70 as the output-side rotary portion, and is allowed to be rotated in the vehicle reverse-running direction (as the other of the opposite directions) relative to the output-side rotary members 70 as the output-side rotary portion, when the two-way clutch TWC is placed in the one-way mode.

In the state in which the two-way clutch TWC is placed in the lock mode, as shown in FIG. 3, the working fluid is supplied to the hydraulic chamber of the hydraulic actuator 41 whereby the pressing plate 74 is moved, against the spring 92, in a direction away from the second output-side rotary member 70b, and the longitudinal end portion of each second strut 72b is moved, by biasing force of the corresponding torsion coil spring 73b, toward the corresponding second recessed portion 78b of the second output-side rotary member 70b, whereby the longitudinal end portion of each second strut 72b can be brought into contact with the second wall surface 80b of the second output-side rotary member 70b. Meanwhile, each first strut 72a can be brought into contact at the longitudinal end portion with the first wall surface 80a of the first output-side rotary member 70a, as in the state of the one-way mode shown in FIG. 2.

In the state in which the two-way clutch TWC is placed in the lock mode, as shown in FIG. 3, when the drive force acting in the vehicle forward-running direction is transmitted to the input-side rotary member 68, the longitudinal end portion of each first strut 72a is brought into contact with the first wall surface 80a of the first output-side rotary member 70a, and the other longitudinal end portion of each first strut 72a is brought into contact with the first stepped portion 82a of the input-side rotary member 68, whereby the input-side rotary member 68 is inhibited from being rotated relative to the first output-side rotary member 70a in the vehicle forward-running direction. In the state of the lock mode of the two-way clutch TWC, when the drive force acting in the vehicle reverse-running direction is transmitted to the input-side rotary member 68, the longitudinal end portion of each second strut 72b is brought into contact with the second wall surface 80b of the second output-side rotary member 70b, and the other longitudinal end portion of each second strut 72b is brought into contact with the second stepped portion 82b of the input-side rotary member 68, whereby the input-side rotary member 68 is inhibited from being rotated relative to the second output-side rotary member 70b in the vehicle reverse-running direction. Thus, in the state of the lock mode of the two-way clutch TWC, the first struts 72a serve as a one-way clutch and the second struts 72b serve as a one-way clutch, so that the two-way clutch TWC is configured to transmit the drive force acting in the vehicle forward-running direction and the drive force acting in the vehicle reverse-running direction. In other words, the input-side rotary member 68 as the input-side rotary portion is inhibited from being rotated in both of the opposite directions relative to the output-side rotary members 70 as the output-side rotary portion, when the two-way clutch TWC is placed in the lock mode. When the vehicle 10 is to run in reverse direction, the vehicle 10 is enabled to run in reverse direction with the two-way clutch TWC being placed in the lock mode. Further, when the vehicle 10 is placed in the driven state by inertia running during the forward running, an engine brake can be generated with the two-way clutch TWC being placed in the lock mode by which the engine 12 is dragged by rotation transmitted from the drive wheels 14 to the engine 12 through the two-way clutch TWC. Thus, in the state of the lock mode of the two-way clutch TWC, the first struts 72a serve as a one-way clutch and the second struts 72b serve as a one-way clutch, so that the two-way clutch TWC is configured to transmit the drive force during the driving state and the driven state of the vehicle 10.

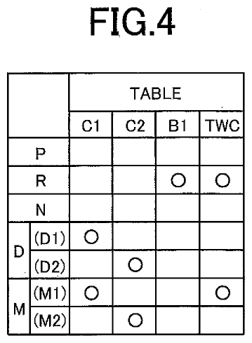

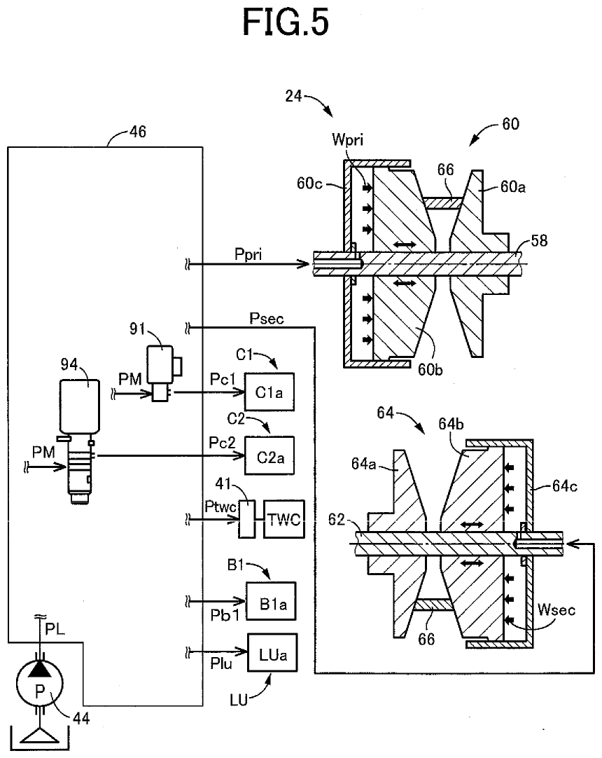

FIG. 4 is a table indicating an operation state of each of the engagement devices for each of a plurality of operation positions POSsh which is selected by operation of a manually-operated shifting device in the form of a shift lever 98 that is provided in the vehicle 10. In FIG. 4, “C1” represents the first clutch C1, “C2” represents the second clutch C2, “B1” represents the first brake B1, and “TWC” represents the two-way clutch TWC. Further, “P”, “R”, “N”, “D” and “M” represent a a parking position P, a reverse position R, a neutral position N, a drive position D and a manual position M, respectively, as the plurality of operation positions POSsh, each of which is to be selected by operation of the shift lever 98. In the table of FIG. 4, “0” in the first clutch C1, second clutch C2 or first brake B1 indicates its engaged state, and blank in the first clutch C1, second clutch C2 or first brake B1 indicates its released state. Further, in the table of FIG. 4, “0” in the two-way clutch TWC indicates its lock mode, and blank in the two-way clutch TWC indicates its one-way mode.

For example, when the shift lever 98 is placed in the parking position P as one of the operating positions POSsh that is a vehicle stop position or in the neutral position N as one of the operating positions POSsh that is a drive-force transmission block position, the first clutch C1, second clutch C2 and first brake B1 are placed in the released positions, as indicated in FIG. 4, so that the drive-force transmitting apparatus 16 is placed in its neutral state in which the drive force is not transmitted along either the first drive-force transmitting path PT1 or the second drive-force transmitting path PT2. It is noted that the neutral state is interpreted to encompass not only a state in which both of the first and second clutches C1, C2 are in the released states, but also, for example, in a state in which the second clutch C2 is in its partially engaged state while the first clutch C1 is in the released state.

When the shift lever 98 is placed in the reverse position R as one of the operating positions POSsh that is a reverse running position, the first brake B1 is placed in the engaged state and the two-way clutch TWC is placed in the lock mode, as indicated in FIG. 4. With the first brake B1 being placed in the engaged state, the drive force acting in the vehicle reverse-running direction is transmitted from the engine 12 to the gear mechanism 28. In this instance, if the two-way clutch TWC is in the one-way mode, the drive force is blocked by the two-way clutch TWC so that reverse running cannot be made. Thus, with the two-way clutch TWC being placed in the lock mode, the drive force acting in the vehicle reverse-running direction is transmitted to the output shaft 30 through the two-way clutch TWC so that reverse running can be made. When the shift lever 98 is placed in the reverse position R, the first brake B1 is placed in the engaged state and the two-way clutch TWC is placed in the lock mode, whereby a reverse gear position is established to transmit the drive force acting in the vehicle reverse-running direction, through the gear mechanism 28 along the first drive-force transmitting path PT1, to the drive wheels 14.

When the shift lever 98 is placed in the drive position D as one of the operating positions POSsh that is a forward running position, the first clutch C1 is placed in the engaged state or the second clutch C2 is placed in the engaged state, as indicated in FIG. 4. In FIG. 4, “D1” and “D2” represent a drive position D1 and a drive position D2, respectively, which are operating positions virtually set in control. When the shift lever 98 is placed in the drive position D, one of the drive position D1 and the drive position D2 is selected depending a running state of the vehicle 10, and the selected one is automatically established. The drive position D1 is established when the vehicle running speed is within a relatively low speed range including zero speed (vehicle stop). The drive position D2 is established when the vehicle running speed is within a relatively high speed range including a middle speed range. For example, during running of the vehicle 10 with the shift lever 98 being placed in the drive position D, when the running state of the vehicle 10 is changed from the low speed range to the high speed range, the drive position D1 is automatically switched to the drive position D2.

For example, when the running state of the vehicle 10 is in a speed range corresponding to the drive position D1 upon placement of the shift lever 98 into the drive position D, the first clutch C1 is engaged and the second clutch C2 is released. In this case, a forward-running gear position is established whereby the drive force acting in the vehicle forward-running direction is transmitted from the engine 12 to the drive wheels 14 along the first drive-force transmitting path PT1 through the gear mechanism 28. Hereinafter, a running mode in which the vehicle 10 runs with the forward-running gear position being established will be referred to as a gear running mode. It is noted that the two-way clutch TWC, which is placed in the one-way mode, transmits the drive force acting in the vehicle forward-running direction, toward the drive wheels 14.

Further, when the running state of the vehicle 10 is in a speed range corresponding to the drive position D2 upon placement of the shift lever 98 into the drive position D, the first clutch C1 is released and the second clutch C2 is engaged. In this case, a forward-running continuously-variable shifting position is established whereby the drive force acting in the vehicle forward-running direction is transmitted from the engine 12 to the drive wheels 14 along the second drive-force transmitting path PT2 through the continuously variable transmission 24. Hereinafter, a running mode in which the vehicle 10 runs with the forward-running continuously-variable shifting position being established will be referred to as a belt running mode. With the forward-running continuously-variable shifting position being established, the vehicle 10 is enabled to run with execution of shifting actions in the continuously variable transmission 24. Thus, when the shift lever 98 is placed into the drive position D as one of the operating positions POSsh, the drive force of the engine 12 is transmitted to the drive wheels 14 along a selected one of the first and second drive-force transmitting paths PT1, PT2, which is selected depending on the running state of the vehicle 10.

When the shift lever 98 is placed in the manual position M as one of the operating positions POSsh, a shift-up operation or a shift-down operation can be executed by a manual operation made by an operator of the vehicle 10. That is, the manual position M is a manual shift position in which a shifting operation can be made by the manual operation made by the operator. For example, when a shift-down operation is manually made by the operator with the shift lever 98 being placed in the manual position M, the first clutch C1 is placed into the engaged state and the two-way clutch TWC is placed into the lock mode whereby the forward-running gear position is established. With the two-way clutch TWC being placed in the lock mode, the drive force can be transmitted through the two-way clutch TWC during the driven state of the vehicle 10 as well as during the driving state of the vehicle 10. During the inertia running, for example, the vehicle 10 is placed in the driven state in which the rotation is transmitted from the drive wheels 14 toward the engine 12. In the driven state, when the shift-down operation is manually executed with the shift lever 98 being placed in the manual position M, the rotation transmitted from the drive wheels 14 is transmitted toward the engine 12 through the two-way clutch TWC that is placed in the lock mode, whereby the engine 12 is dragged to generate an engine brake. Thus, when the shift-down operation is executed with the shift lever 98 being placed in the manual position M, the forward-running gear position is established so that the drive force is transmitted to the drive wheels 14 along the first drive-force transmitting path PT1 through the gear mechanism 28, and so that the rotation transmitted from the drive wheels 14 is transmitted toward the engine 12 along the first drive-force transmitting path PT1 so as to generate the engine brake during the inertia running.

When a shift-up operation is manually made by the operator with the shift lever 98 being placed in the manual position M, the second clutch C2 is placed into the engaged state whereby the forward-running continuously-variable shifting position is established so that the drive force is transmitted to the drive wheels 14 along the second drive-force transmitting path PT2 through the continuously variable transmission 24. Thus, with the shift lever 98 being placed in the manual position M, a manual shifting can be executed by manual operation made by the operator, to select one of the forward-running gear position and the forward-running continuously-variable shifting position. When the forward-running gear position is selected, the drive force can be transmitted along the first drive-force transmitting path PT1. When the forward-running continuously-variable shifting position is selected, the drive force can be transmitted along the second drive-force transmitting path PT2. The case in which the shift-down operation has been made with the shift lever 98 being placed in the manual position M, corresponds to “M1” (position M1) that is shown in FIG. 4. The case in which the shift-up operation has been made with the shift lever 98 being placed in the manual position M, corresponds to “M2” (position M2) that is shown in FIG. 4. Although the positions M1, M2 do not exist in appearance, for the purpose of convenience in the following description, it will be described that “the position M1 is established” when the shift-down operation has been manually made with the shift lever 98 being placed in the manual position M, and it will be described that “the position M2 is established” when the shift-up operation has been manually made with the shift lever 98 being placed in the manual position M.

As indicated in the table of FIG. 4, the first clutch C1 is placed in its engaged state only when the forward-running gear position (corresponding to the drive position D1 and position M1 shown in FIG. 4) is to be establish to enable the drive force to be transmitted along the first drive-force transmitting path PT1. In other words, the first clutch C1 is not engaged when a gear position other than the forward-running gear position is to be established.

FIG. 5 is a view schematically showing the hydraulic control unit 46 configured to control operation states of the continuously variable transmission 24 and the drive-force transmitting apparatus 16. As shown in FIG. 5, the primary pulley 60 constituting the continuously-variable transmission 24 includes a fixed sheave 60a connected to the primary shaft 58, a movable sheave 60b unrotatable about an axis of the primary shaft 58 and axially movable relative to the fixed sheave 60a, and a primary thrust applier in the form of a hydraulic actuator 60c configured to apply a primary thrust Wpri to the movable sheave 60b. The primary thrust Wpri is a thrust (=primary pressure Ppri·pressure receiving area) for changing a width of a V-shaped groove defined between the fixed and movable sheaves 60a, 60b of the primary pulley 60. That is, the primary thrust Wpri is a thrust applied to the primary pulley 60 from the hydraulic actuator 60c, to clamp the transmission belt 66 that is mounted on the primary pulley 60. The primary pressure Ppri is a hydraulic pressure applied from the hydraulic control unit 46 to the hydraulic actuator 60c, and serves as a pulley hydraulic pressure for generating the primary thrust Wpri.

Meanwhile, the secondary pulley 64 includes a fixed sheave 64a connected to the secondary shaft 62, a movable sheave 64b unrotatable about an axis of the secondary shaft 62 and axially movable relative to the fixed sheave 64a, and a secondary thrust applier in the form of a secondary hydraulic actuator 64c configured to apply a secondary thrust Wsec to the movable sheave 64b. The secondary thrust Wsec is a thrust (=secondary pressure Psec*pressure receiving area) for changing a width of a V-shaped groove defined between the fixed and movable sheaves 64a, 64b of the secondary pulley 64. That is, the secondary thrust Wsec is a thrust applied to the secondary pulley 64 from the secondary hydraulic actuator 64c, to clamp the transmission belt 66 that is mounted on the secondary pulley 64. The secondary pressure Psec is a hydraulic pressure applied from the hydraulic control unit 46 to the secondary hydraulic actuator 64c, and serves as a pulley hydraulic pressure for generating the secondary thrust Wsec.

In the continuously-variable transmission mechanism 24, the primary and secondary pressures Ppri, Psec are controlled by the hydraulic control unit 46 that is controlled by the electronic control apparatus 100, whereby the primary and secondary thrusts Wpri, Wsec are respectively controlled. With the primary and secondary thrusts Wpri, Wsec being controlled, the widths of the V-shaped grooves of the respective pulleys 60, 64 are controlled to be changeable whereby a belt winding dimeter (effective diameter) of each of the pulleys 60, 64 is changeable and accordingly a gear ratio γcvt (=primary rotational speed Npri/secondary rotational speed Nsec) of the continuously-variable transmission mechanism 24 is changeable. Further, with the primary and secondary thrusts Wpri, Wsec being controlled, the belt clamping force is controlled such that slipping of the transmission belt 66 is not caused. That is, with the primary and secondary thrusts Wpri, Wsec being controlled, the gear ratio γcvt of the continuously-variable transmission mechanism 24 is controlled to a target gear ratio γcvttgt while the transmission belt 66 is prevented from being slipped. It is noted that the primary rotational speed Npri represents a rotational speed of the primary shaft 58, input shaft 22 and primary pulley 60, and that the secondary rotational speed Nsec represents a rotational speed of the secondary shaft 62 and secondary pulley 64.

The hydraulic control unit 46 is constituted to include a plurality of control valves such as electromagnetic valves in the form of solenoid valves. The plurality of solenoid valves include an on-off solenoid valve 91 configured to control a C1 control pressure Pc1 that is applied to a hydraulic actuator C1a of the first clutch C1 and a linear solenoid valve 94 configured to control a C2 control pressure Pct that is applied to a hydraulic actuator C2a of the second clutch C2. The on-off solenoid valve 91 is a simple solenoid valve that is to be placed in either one of an open position and a closed position, without an operation position intermediate between the open and closed positions. It is noted that the on-off solenoid valve 91 and the linear solenoid valve 94, which are known solenoid valves, will not be described in detail.

Although not being shown in FIG. 5, the hydraulic control unit 46 includes a plurality of solenoid valves configured to directly or indirectly control a B1 control pressure Pb1 that is applied to a hydraulic actuator B1a of the first brake B1, a TWC pressure Ptwc that is applied to the hydraulic actuator 41 so as to switch the two-way clutch TWC between the one-way mode and the lock mode, a primary pressure Ppri that is supplied to the hydraulic actuator 60c of the primary pulley 60, a secondary pressure Psec that is supplied to the hydraulic actuator 64c of the secondary pulley 64, and a LU pressure Plu that is supplied for controlling the lock-up clutch LU. In the present embodiment, each of the solenoid valves configured to control these hydraulic pressures is constituted by a linear solenoid valve.

As described above, the C1 control pressure Pc1, which is applied to the hydraulic actuator C1a of the first clutch C1, is controlled by the on-off solenoid valve 91. The on-off solenoid valve 91 is configured to receive an original pressure in the form of a modulator pressure PM that is regulated by a modulator valve (not shown), and to output the C1 control pressure Pc1 that is applied to the hydraulic actuator C1a. For example, when the on-off solenoid valve 91 is placed in its ON state, the modulator pressure PM is outputted as the C1 control pressure Pc1. When the on-off solenoid valve 91 is placed in its OFF state, the working fluid of the hydraulic actuator C1a is discharged whereby the C1 control pressure Pc1 is reduced to zero. In the on-off solenoid valve 91, the command pressure value of the C1 control pressure Pc1 is to be set to either the modulator pressure PM or zero, and cannot be set to a pressure value intermediate between the modulator pressure PM and zero. It is noted that a hydraulic circuit of the hydraulic control unit 46 is arranged such that the on-off solenoid valve 91 is connected only to the hydraulic actuator C1a of the first clutch C1, and is not connected to hydraulic actuators of other engagement devices other than the first clutch C1.

The C2 control pressure Pc2, which is applied to the hydraulic actuator C2a of the second clutch C2, is controlled by the linear solenoid valve 94. The linear solenoid valve 94 is configured to receive an original pressure in the form of the modulator pressure PM, and is capable of finely controlling the C2 control pressure Pc2 that is applied to the hydraulic actuator C2a, based on an electrical signal (command electric current) supplied to the linear solenoid valve 94.

Referring back to FIG. 1, the vehicle 10 is provided with the electronic control apparatus 100 as a controller including the control apparatus constructed according to present invention. For example, the electronic control apparatus 100 includes a so-called microcomputer incorporating a CPU, a ROM, a RAM and an input-output interface. The CPU performs control operations of the vehicle 10, by processing various input signals, according to control programs stored in the ROM, while utilizing a temporary data storage function of the RAM. The electronic control apparatus 100 is configured to perform, for example, an engine control operation for controlling an output of the engine 12, a shifting control operation and a belt-clamping-force control operation for the continuously-variable transmission 24, and a hydraulic-pressure control operation for switching the operation state of each of the plurality of engagement devices (C1, B1, C2, TWC). The electronic control apparatus 100 may be constituted by two or more control units exclusively assigned to perform different control operations such as the engine control operation and the hydraulic-pressure control operation.

The electronic control apparatus 100 receives various input signals based on values detected by respective sensors provided in the vehicle 10. Specifically, the electronic control apparatus 100 receives: an output signal of an engine speed sensor 102 indicative of an engine rotational speed Ne which is a rotational speed of the engine 12; an output signal of a primary speed sensor 104 indicative of a primary rotational speed Npri which is a rotational speed of the primary shaft 58 which is equivalent to an input-shaft rotational speed Nin; an output signal of a secondary speed sensor 106 indicative of a secondary rotational speed Nsec which is a rotational speed of the secondary shaft 62; an output signal of an output speed sensor 108 indicative of an output-shaft rotational speed Nout which is a rotational speed of the output shaft 30 and which corresponds to the running speed V of the vehicle 10; an output signal of an input speed sensor 109 indicative of an input rotational speed Ntwcin which is a rotational speed of the input-side rotary member 68 of the two-way clutch TWC; an output signal of an accelerator-operation amount sensor 110 indicative of the above-described operation amount θacc of the accelerator pedal 45 which represents an amount of accelerating operation made by the vehicle operator; an output signal of a throttle-opening degree sensor 112 indicative of the throttle opening degree tap; an output signal of a shift position sensor 114 indicative of an operation position POSsh of a manually-operated shifting device in the form of the shift lever 98 provided in the vehicle 10; and an output signal of a temperature sensor 116 indicative of a working fluid temperature THoil that is a temperature of a working fluid in the hydraulic control unit 46. It is noted that the input-shaft rotational speed NM (=primary rotational speed Npri) is equivalent to a rotational speed of the turbine impeller 20t of the of the torque converter 20. Further, the electronic control apparatus 100 calculates an actual gear ratio γcvt (=Npri/Nsec) that is an actual value of the gear ratio γcvt of the continuously-variable transmission 24, based on the primary rotational speed Npri and the secondary rotational speed Nsec. Moreover, the electronic control apparatus 100 calculates an output rotational speed Ntwcout of the first and second output-side rotary members 70a, 70b of the two-way clutch TWC, based on the output-shaft rotational speed Nout.

Further, the electronic control apparatus 100 generates various output signals which are supplied to various devices such as the engine control device 42 and the hydraulic control unit 46 and which include an engine-control command signal Se for controlling the engine 12, a hydraulic control command signal Scvt for performing hydraulic controls such as controls of the shifting action and the belt clamping force of the continuously-variable transmission 24, a hydraulic-control command signal Scbd for performing hydraulic controls of operation states of the plurality of engagement devices, and a hydraulic control command signal Slu for performing hydraulic controls of an operation state of the lock-up clutch LU.

The hydraulic control unit 46, which receives the above-described hydraulic control command signals, outputs the C1 control pressure Pc1 that is supplied to the hydraulic actuator C1a of the first clutch C1, the B1 control pressure Phi that is supplied to the hydraulic actuator B1a of the first brake B1, the C2 control pressure Pc2 that is supplied to the hydraulic actuator C2a of the second clutch C2, the TWC pressure Ptwc that is supplied to the hydraulic actuator 41 configured to switch the two-way clutch TWC between the one-way mode and the lock mode, the primary pressure Ppri that is supplied to the hydraulic actuator 60c of the primary pulley 60, the secondary pressure Psec that is supplied to the hydraulic actuator 64c of the secondary pulley 64, and the LU pressure Plu that is supplied for controlling the lock-up clutch LU.

For performing various control operations in the vehicle 10, the electronic control apparatus 100 includes an engine control means or portion in the form of an engine control portion 120 and a transmission shifting control means or portion in the form of a transmission-shifting control portion 122.

The engine control portion 120 calculates a required drive force Fdem, for example, by applying the accelerator operation amount θacc and the running velocity V to a predetermined or stored relationship (e.g., drive force map) that is obtained by experimentation or determined by an appropriate design theory. The engine control portion 120 sets a target engine torque Tet that ensures the required drive force Fdem, and outputs the engine-control command signal Se for controlling the engine 12 so as to obtain the target engine torque Tet. The outputted engine-control command signal Se is supplied to the engine control device 42.

When the operation position POSsh of the shift lever 98 is switched from the neutral position N to the drive position D, for example, during stop of the vehicle 10 or running of the vehicle 10 at a low running speed, for example, the transmission-shifting control portion 122 supplies, to the hydraulic control unit 46, the hydraulic-control command signal Scbd requesting engagement of the first clutch C1, whereby the forward gear running mode is established to enable forward running of the vehicle 10 by the drive force transmitted along the first drive-force transmitting path PT1. When the operation position POSsh of the shift lever 98 is switched from the neutral position N to the reverse position R during stop of the vehicle 10, the transmission-shifting control portion 122 supplies, to the hydraulic control unit 46, the hydraulic-control command signal Scbd requesting engagement of the first brake B1 and switching of the two-way clutch TWC to the lock mode, whereby the reverse gear running mode is established to enable reverse running of the vehicle 10 by the drive force transmitted along the first drive-force transmitting path PT1.

During running of the vehicle 10 in the belt running mode by the drive force with the drive force transmitted along the second drive-force transmitting path PT2, for example, the transmission-shifting control portion 122 outputs the hydraulic control command signal Scvt by which the gear ratio γ of the continuously variable transmission 24 is controlled to a target gear ratio γtgt that is calculated based on, for example, the accelerator operation amount θacc and the vehicle running speed V. Specifically, the transmission-shifting control portion 122 stores therein a predetermined relationship (e.g., shifting map) which assures an appropriately adjusted belt clamping force in the continuously variable transmission 24 and which establishes the target gear ratio γtgt of the continuously variable transmission 24 that enables the engine 12 to be operated at an operating point lying on an optimum line (e.g., engine optimum-fuel-efficiency line). The transmission-shifting control portion 122 determines a target primary pressure Ppritgt as a command pressure value of the primary pressure Ppri that is to be supplied to the hydraulic actuator 60c of the primary pulley 60 and a target secondary pressure Psectgt as a command pressure value of the secondary pressure Psec that is to be supplied to the hydraulic actuator 64c of the secondary pulley 64, in accordance with the above-described stored relationship, based on the accelerator operation amount θacc and the vehicle running speed V. Thus, the transmission-shifting control portion 122 executes a shifting control of the continuously variable transmission 24, by supplying, to the hydraulic control unit 46, the hydraulic control command signal Scvt by which the primary pressure Ppri and the secondary pressure Psec are to be controlled to the target primary pressure Ppritgt and the target secondary pressure Psectgt, respectively. It is noted that the shifting control of the continuously variable transmission 24, which is a known technique, will not be described in detail.

Further, when the shift lever 98 is placed in the drive position D, the transmission-shifting control portion 122 executes a switching control operation for switching the running mode between the gear running mode (in which the drive force is to be transmitted along the first drive-force transmitting path PT1) and the belt running mode (in which the drive force is to be transmitted along the second drive-force transmitting path PT2). Specifically, the transmission-shifting control portion 122 stores therein a predetermined relationship in the form of a shifting map for shifting from one of first and second speed positions to the other, wherein the first speed position corresponds the gear ratio EL (that corresponds to “first gear ratio” recited in the appended claims) of the gear mechanism 28 in the gear running mode, and the second speed position corresponds to the highest gear ratio γmax (that corresponds to “second gear ratio” recited in the appended claims) of the continuously variable transmission 24 in the belt running mode. In the shifting map, which is constituted by, for example, the running speed V and the accelerator operation amount θacc, a shift-up line is provided for determining whether a shift-up action to the second speed position, namely, switching to the belt running mode is to be executed or not, and a shift-down line is provided for determining whether a shift-down action to the first speed position, namely, switching to the gear running mode is to be executed or not. The transmission-shifting control portion 122 determines whether the shift-up action or shift-down action is to be executed or not, by applying actual values of the running speed V and the accelerator operation amount θacc to the shifting map, and executes the shift-up action or shift-down action (namely, switches the running mode), depending on result of the determination. For example, when a running state point, which is defined by a combination of the actual values of the running speed V and the accelerator operation amount θacc, is moved across the shift-down line in the shifting map during the running in the belt running mode, for example, it is determined that there is a request (i.e., shift-down request) requesting the shift-down action to the first speed position, namely, there is a request for the switching to the gear running mode. When the running state point is moved across the shift-up line in the shifting map during the running in the gear running mode, for example, it is determined that there is a request (i.e., shift-up request) requesting the shift-up action to the second speed position, namely, there is a request for the switching to the belt running mode. It is noted that the gear running mode corresponds to “D1” (drive position D1) shown in FIG. 4 and that the belt running mode corresponds to “D2” (drive position D2) shown in FIG. 4.

For example, during the running in the gear running mode (corresponding to the drive position D1 shown in FIG. 4) with the shift lever 98 being placed in the drive position D, when determining that the request for the shift-up action to the second speed position, i.e., the switching to the belt running mode (corresponding to the drive position D2 shown in FIG. 4), is issued or made, the transmission-shifting control portion 122 outputs, to the hydraulic control unit 46, a command requesting release of the first clutch C1 and engagement of the second clutch C2, whereby the second drive-force transmitting path PT2 is established in place of the first drive-force transmitting path PT1 so that the drive force can be transmitted along the second drive-force transmitting path PT2 in the drive-force transmitting apparatus 16. That is, the transmission of the drive force along the first drive-force transmitting path PT1 is cut off, and the first drive-force transmitting path PT1 is switched to the second drive-force transmitting path PT2.

As described above, when the operation position POSsh of the shift lever 98 is switched from the neutral position N to the drive position D, for example, during stop of the vehicle 10 or running of the vehicle 10 at a low running speed, the first clutch C1 is switched to the engaged state. With the first clutch C1 being switched to the engaged state, the vehicle 10 is placed in the forward gear running mode in which the drive force is to be transmitted along the first drive-force transmitting path PT1 through the first clutch C1. In this instance, since the C1 control pressure Pa applied to the first clutch C1 is controlled by the on-off solenoid valve 91, the C1 control pressure Pc1 cannot be finely controlled, so that there is a risk of generation of a shock upon switching of the operation position POSsh from the neutral position N to the drive position D, if the first clutch C1 is directly engaged. On the other hand, in the present embodiment, when the operation position POSsh is switched from the neutral position N to the drive position D, namely, when the first clutch C1 is to be placed in the engaged state during the neutral state of the drive-force transmitting apparatus 16, control operations are executed as described below, such that the first clutch C1 is placed in the engaged state without the shock being generated.

The electronic control apparatus 100 further includes a switching determining means or portion in the form of a switching determining portion 126, a C2-engagement determining means or portion in the form of a C2-engagement determining portion 128, and a C1-engagement determining means or portion in the form of a C1-engagement determining portion 130. There will be described control functions of these portions 126, 128, 130.

The switching determining portion 126 determines whether there is a request for switching the drive-force transmitting apparatus 16 from the neutral state to the gear running mode in which the vehicle 10 is caused to run with the first clutch C1 being engaged. In this instance, the switching determining portion 126 determines that the drive-force transmitting apparatus 16 is in the neutral state, for example, when the shift lever 98 is placed in the neutral position N. Further, when determining that the drive-force transmitting apparatus 16 is in the neutral state, the switching determining portion 126 determines whether the operation position POSsh of the shift lever 98 has been switched from the neutral position N to the drive position D. When determining that the operation position POSsh has been switched from the neutral position N to the drive position D, the switching determining portion 126 determines that the request for switching the drive-force transmitting apparatus 16 from the neutral state to the gear running mode is made.

The C2-engagement determining portion 128 determines whether the second clutch C2 has been fully engaged. The C2-engagement determining portion 128 first determines whether the command pressure value of the C2 control pressure Pc2 (applied to the second clutch C2) is equal to or larger than a determination threshold value Pc2m. The determination threshold value Pc2m is a predetermined value which is obtained by experimentation or determined by an appropriate design theory and which is required to avoid slippage of the second clutch C2. Further, when determining that the command pressure value of the C2 control pressure Pc2 is not smaller than the determination threshold value Pc2m, the C2-engagement determining portion 128 calculates a rotational speed difference ΔNc2 between rotational speeds of rotary elements that are located on respective front and rear sides of the second clutch C2 in the second drive-force transmitting path PT2, and then determines whether the calculated rotational speed difference ΔNc2 is equal to or smaller than a determination threshold value α. The C2-engagement determining portion 128 determines that the second clutch C2 has been fully engaged when the command pressure value of the C2 control pressure Pc2 is not smaller than the determination threshold value Pc2m and the rotational speed difference ΔNc2 is not larger than the determination threshold value α. The determination threshold value α is a predetermined value which is obtained by experimentation or determined by an appropriate design theory and based on which it can be determined that no slippage occurs in the second clutch C2. The rotational speed difference ΔNc2 is calculated as a difference (=|Nsec−Nout|) between the secondary rotational speed Nsec of the secondary shaft 62 and the output-shaft rotational speed Nout of the output shaft 30.

The C1-engagement determining portion 130 determines whether the first clutch C1 has been fully engaged. The C1-engagement determining portion 130 first determines whether the on-off solenoid valve 91 has been placed in the ON state, namely, whether the command pressure value of the C1 control pressure Pc1 has been set to the modulator pressure PM. Further, when determining that the on-off solenoid valve 91 has been placed in the ON state, the C1-engagement determining portion 130 calculates a rotational speed difference ΔNc1 between rotational speeds of rotary elements that are located on respective front and rear sides of the first clutch C1 in the first drive-force transmitting path PT1, and then determines whether the calculated rotational speed difference ΔNc1 is equal to or smaller than a determination threshold value β. The C1-engagement determining portion 130 determines that the first clutch C1 has been fully engaged when the on-off solenoid valve 91 is in the ON state and the rotational speed difference ΔNc1 is not larger than the determination threshold value β. The determination threshold value β is a predetermined value which is obtained by experimentation or determined by an appropriate design theory and based on which it can be determined that no slippage occurs in the first clutch C1. The rotational speed difference ΔNc1 is calculated as a difference (=|N26c−Ns26s|) between a rotational speed N26c of the carrier 26c of the forward/reverse switching device 26 and a rotational speed N26s of the sun gear 26s of the forward/reverse switching device 26. It is noted that the rotational speed N26c of the carrier 26c is equal to the input-shaft rotational speed Nin, and that the rotational speed N26s of the sun gear 26s is calculated based on the input rotational speed Ntwcin of the input-side rotary member 68 of the two-way clutch TWC and a gear ratio of the gear mechanism 28 (gear ratio between the small and large gears 48, 52).

When it is determined by the switching determining portion 126 that the request for switching the drive-force transmitting apparatus 16 from the neutral state to the gear running mode is made, the transmission-shifting control portion 122 outputs a command requesting engagement of the second clutch C2, and the outputted command is supplied to the hydraulic control unit 46, for thereby causing the second clutch C2 to be engaged. Specifically, the transmission-shifting control portion 122 outputs a command requesting an actual pressure value of the C2 control pressure Pc2 (which is to be actually supplied to the hydraulic actuator C2a of the second clutch C2) to follow the command pressure value of the C2 control pressure Pc2 which is a predetermined value, and the outputted command is supplied to the hydraulic control unit 46. The command pressure value of the C2 control pressure Pc2 applied to the second clutch C2 is set to a value, for example, which is held at a predetermined stand-by pressure value Pst after being temporarily increased to a predetermined quick-fill pressure value Pck, and is then increased at a predetermined rate (gradient). With the actual pressure value of the C2 control pressure Pc2 being increased to follow the command pressure value by control made by the transmission-shifting control portion 122, the torque capacity of the second clutch C2 is increased in proportion to increase of the actual pressure value of the C2 control pressure Pc2.

When the torque becomes transmittable along the second drive-force transmitting path PT2 as a result of increase of the torque capacity of the second clutch C2, an inertia phase is started whereby the input-shaft rotational speed Nin starts to be reduced. During the inertia phase, the second C2 control pressure Pc2 applied to the second clutch C2 is finely controlled by the linear solenoid valve 94, for example, such that the input-shaft rotational speed Nin is reduced at a predetermined target rate (gradient) dNin/dt. Thus, with the C2 control pressure Pct being finely controlled in process of engagement of the second clutch C2, a shock generated during the inertia phase is reduced. Then, when the second clutch C2 is placed in the fully engaged state (namely, in a state in which no slippage occurs in the second clutch C2), the inertia phase (which has been started upon start of engagement of the second clutch C2) is terminated. In this instance, the input-shaft rotational speed Nin becomes zero where the vehicle 10 is being stopped, and becomes a speed value dependent on the vehicle running speed V and the gear ratio γcvt (practically, the highest gear ratio max) of the continuously-variable transmission 24 where the vehicle 10 is running at a low speed. It is noted that a determination as to whether the second clutch C2 is fully engaged or not is made by the C2-engagement determining portion 128.

When it is determined by the C2-engagement determining portion 128 that the second clutch C2 is fully engaged, the transmission-shifting control portion 122 outputs a command requesting engagement of the first clutch C1, and the outputted command is supplied to the hydraulic control unit 46, for thereby causing the first clutch C1 to be engaged. Specifically, the transmission-shifting control portion 122 outputs a command requesting the on-off solenoid valve 91 to be placed in the ON state, and the outputted command is supplied to the hydraulic control unit 46, for thereby causing the on-off solenoid valve 91 to output the modulator pressure PM as the command pressure value of the C1 control pressure Pc1. In this instance, although the C1 control pressure Pc1, which is controlled by the on-off solenoid valve 91, cannot be finely controlled in process of engagement of the first clutch C1, the shock generated in process of engagement of the first clutch C1 is reduced because the second clutch C2 has been fully engaged and the inertia phase has been terminated in this stage. Further, the first clutch C1 as well as the second clutch C2 is placed in the engaged state when the first clutch C1 is fully engaged. However, since the gear ratio EL established in the first drive-force transmitting path PT1 is higher than the highest gear ratio γmax established in the second drive-force transmitting path PT2, the first drive-force transmitting path PT1 is disconnected by the two-way clutch TWC. Thus, in the drive-force transmitting apparatus 16, even when the first and second clutches C1, C2 are both in the engaged states, the first and second drive-force transmitting paths PT1, PT2 are avoided from interfering with each other in transmission of the drive force.

Then, when the engagement of the first clutch C1 is completed, it is determined by the C1-engagement determining portion 130 that the first clutch C1 has been completely engaged, and the transmission-shifting control portion 122 outputs a command requesting the second clutch C2 to be released. The outputted command is supplied to the hydraulic control unit 46, thereby causing the second clutch C2 to be released. Specifically, for causing the second clutch C2 to be released, the transmission-shifting control portion 122 controls the linear solenoid valve 94 such that the C2 control pressure Pc2 applied to the second clutch C2 is gradually reduced at a certain rate (gradient) L. In this process of release of the second clutch C2, the drive-force transmitting path PT is switched from the second drive-force transmitting path PT2 to the first drive-force transmitting path PT1. In this instance, where the vehicle 10 runs at a low running speed, the input-shaft rotational speed Nin becomes synchronized with a rotational speed that is dependent on the gear ratio EL in the process of release of the second clutch C2, with the generated shock being reduced by the gradual reduction of the C2 control pressure Pc2 at the certain rate L. When the input-shaft rotational speed Nin has become equal to the synchronized rotational speed, the C2 control pressure Pc2 is made zero whereby the second clutch C2 is fully released. It is noted that the certain rate L is a predetermined rate value which is obtained by experimentation or determined by an appropriate design theory and which is required to reduce the shock generated in the process of released of the second clutch C2.

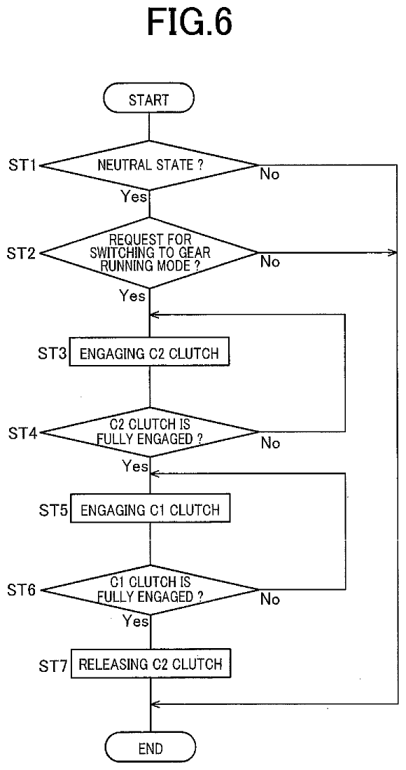

FIG. 6 is a flow chart showing a main part of a control routine executed by the electronic control apparatus 100, namely, a control routine that is executed for switching the transmitting apparatus 16 from the neutral state to the gear running mode when the operation position POSsh of the shift lever 98 has been switched from the neutral position N to the drive position D while the vehicle 10 is stopped or running at a low running speed. This control routine is executed in a repeated manner.

The control routine is initiated with step ST1 corresponding to control function of the switching determining portion 126, which is implemented to determine whether the vehicle 10 is in the neutral state or not, depending on whether the operation position POSsh of the shift lever 98 is the neutral position N or not. When a negative determination is made at step ST1, one cycle of execution of the control routine is completed. When an affirmative determination is made at step ST1, step ST2 corresponding to control function of the switching determining portion 126 is implemented to determine whether the request for switching the transmitting apparatus 16 from the neutral state to the gear running mode is made or not, depending on whether the operation position POSsh has been switched from the neutral position N to the drive position D or not. When a negative determination is made at step ST2, one cycle of execution of the control routine is completed. When an affirmative determination is made at step ST2, step ST3 corresponding to control function of the transmission-shifting control portion 122 is implemented to cause the second clutch C2 to be engaged. In this instance, the C2 control pressure Pc2 applied to the second clutch C2 is finely controlled such that the input-shaft rotational speed Nin is reduced at the target rate dNin/dt, thereby reducing a shock generated in the process of engagement of the second clutch C2. Then, step ST3 is followed by step ST4 corresponding to control function of the C2-engagement determining portion 128, which is implemented to determine whether the second clutch C2 has been fully engaged or not. When a negative determination is made at step ST4, the control flow goes back to step ST3 so as to cause the engaging action of the second clutch C2 to be continued. When an affirmative determination is made at step ST4, step ST5 corresponding to control function of the transmission-shifting control portion 122 is implemented to cause the first clutch C1 to be engaged. Then, step ST6 corresponding to control function of the C1-engagement determining portion 130 is implemented to determine whether the first clutch C1 has been fully engaged or not. When a negative determination is made at step ST6, the control flow goes back to step ST5 so as to cause the engaging action of the first clutch C1 to be continued. When an affirmative determination is made at step ST6, step ST7 corresponding to control function of the transmission-shifting control portion 122 is implemented to cause the second clutch C2 to be released. In this instance, the C2 control pressure Pc2 applied to the second clutch C2 is gradually reduced at the certain rate L whereby a shock generated in the process of release of the second clutch C2 is reduced. When the C2 control pressure Pc2 of the second clutch C2 becomes zero, the second clutch C2 is fully released so that the switching to the gear running mode is completed.

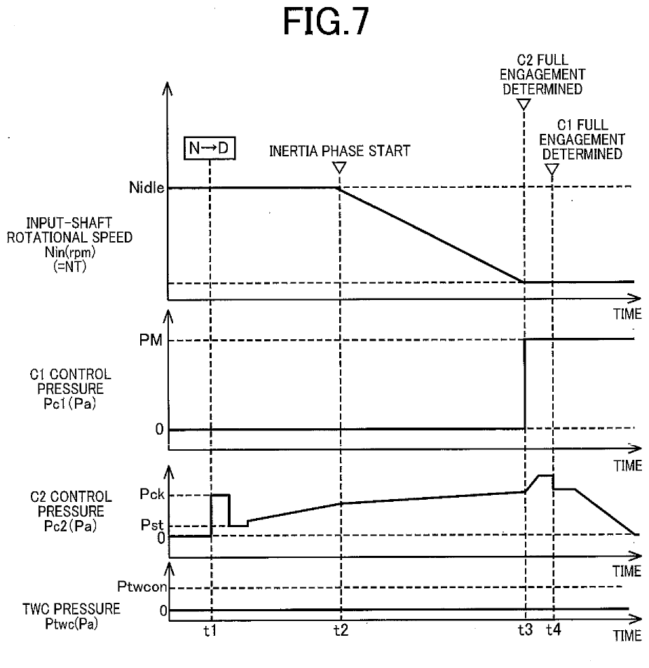

FIG. 7 is a time chart showing a result of the control routine that is executed as shown in the flow chart of FIG. 6, specifically, a result of the control routine that is executed when the drive-force transmitting apparatus 16 is to be switched from the neutral state to the gear running mode. In FIG. 7, ordinate axes represent, as seen from top to bottom, the input-shaft rotational speed Nin (i.e., turbine rotational speed NT), the C1 control pressure Pc1 (command pressure value), the C2 control pressure Pc2 (command pressure value) and the TWC pressure Ptwc (command pressure value). It is noted that since the TWC pressure Ptwc applied to the hydraulic actuator 41 of the two-way clutch TWC is held at zero, as shown in FIG. 7, the two-way clutch TWC is held in the one-way mode.

As shown in FIG. 7, at a point t1 of time at which the operation position POSsh of the shift lever 98 is switched from the neutral position N to the drive position D, the engagement of the second clutch C2 is first started, for starting to switch the drive-force transmitting apparatus 16 from the neutral state to the gear running mode. Specifically, as shown in FIG. 7, the command pressure value of the C2 control pressure Pc2 applied to the second clutch C2 is temporarily set to the predetermined quick-fill pressure value Pck and then temporarily held at the stand-by pressure value Pst. Further, the command pressure value of the C2 control pressure Pc2 is gradually increased at the predetermined rate, after having been temporarily held at the stand-by pressure value Pst. The actual pressure value of the C2 control pressure Pc2 is increased so as to follow the command pressure value of the C2 control pressure Pc2.

At a point t2 of time, the inertia phase is started as the engaging action of the second clutch C2 is started. In a stage from the point t2 of time to a point t3 of time, the C2 control pressure Pc2 applied to the second clutch C2 is finely controlled by the linear solenoid valve 94 such that the input-shaft rotational speed Nin is reduced at the predetermined target rate dNin/dt. At the point t3 of time at which the second clutch C2 is fully engaged, the input-shaft rotational speed Nin becomes synchronized with the synchronized rotational speed that is the rotational speed of the input shaft 22 after engagement of the second clutch C2. The synchronized rotational speed corresponds to zero where the vehicle 10 is being stopped, and corresponds to a speed value dependent on the vehicle running speed V and the gear ratio γcvt of the continuously-variable transmission 24 where the vehicle 10 is running at a low speed.

At the point t3 of time at which it is determined that the second clutch C2 has been fully engaged, the first clutch C1 starts to be engaged. The C1 control pressure Pc1 applied to the first clutch C1, which is controlled by the on-off solenoid valve 91, is increased at a step from zero to the modulator pressure PM. In this instance, although the C1 control pressure Pc1 cannot be finely controlled in the process of engagement of the first clutch C1, it is possible to reduce a shock generated by change of the input-shaft rotational speed Nin in the process of engagement of the first clutch C1, since the input-shaft rotational speed Nin has been already reduced to the synchronized rotational speed as a result of the full engagement of the second clutch C2. At a point t4 of time at which it is determined that the first clutch C has been fully engaged, the second clutch C2 starts to be released. After the point t4 of time, the C2 control pressure Pc2 applied to the second clutch C2 is temporarily held at a constant value, and then is gradually reduced. With the gradual reduction of the C2 control pressure Pc2, a shock generated in process of release of the second clutch C2 is reduced. When the C2 control pressure Pc2 becomes zero, the switching to the gear running mode is completed.

As described above, in the present embodiment, in the case in which the first clutch C1 is to be placed into the engaged state during the neutral state of the drive-force transmitting apparatus 16, so as to switch the drive-force transmitting apparatus 16 from the neutral state to the gear running mode, the second clutch C2 is first engaged to establish the second drive-force transmitting path PT2 (namely, to place the second drive-force transmitting path PT2 in a drive-force transmittable state), and then the first clutch C1 is engaged after the second clutch C2 is engaged, whereby a shock generated in process of engagement of the first clutch C1 can be reduced although the hydraulic pressure applied to the first clutch C1 cannot be finely controlled. Further, when the engagement of the first clutch C1 is completed, the second clutch C2 is released so as to establish the first drive-force transmitting path PT1 (namely, to place the first drive-force transmitting path PT1 in a drive-force transmittable state), whereby the vehicle 10 is enabled to run with the drive force being transmitted along the first drive-force transmitting path PT1. Further, since the C1 control pressure Pa applied to the first clutch C1 is controlled by the on-off solenoid valve 91, the manufacturing cost can be made lower than in an arrangement in which the C1 control pressure Pc1 applied to the first clutch C1 is controlled by a linear solenoid valve.

In the present embodiment, the gear ratio EL established in the first drive-force transmitting path PT1 is higher than the highest gear ratio γmax established in the second drive-force transmitting path PT2. Therefore, when the first and second clutches C1, C2 are both engaged, the first drive-force transmitting path PT1 is disconnected by the two-way clutch TWC, so that the first and second drive-force transmitting paths PT1, PT2 are avoided from interfering with each other in transmission of the drive force. Further, when the engagement of the first clutch C1 is completed, the C2 control pressure Pct applied to the second clutch C2 is reduced at the given rate. Thus, a shock generated in process of release of the second clutch C2 is reduced.

There will be described another embodiment of this invention. The same reference signs as used in the above-described embodiment will be used in the following embodiment, to identify the functionally corresponding elements, and descriptions thereof are not provided.

### Second Embodiment

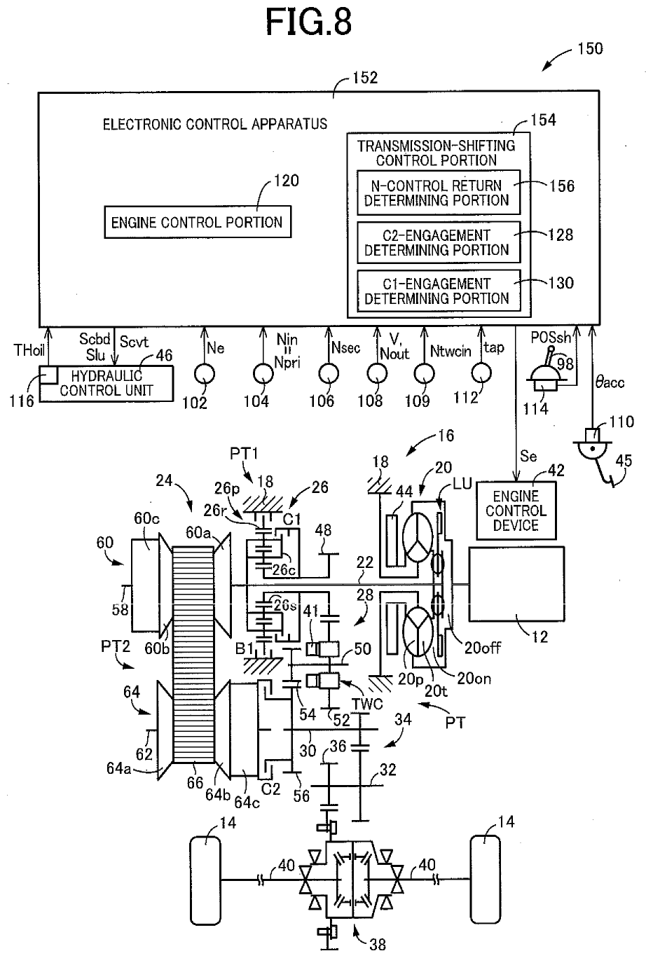

FIG. 8 is a schematic view showing a construction of a vehicle 150 to be controlled by an electronic control apparatus 152 according to this second embodiment of the present invention. In FIG. 8, the drive-force transmitting apparatus 16 is the same as in the above-described first embodiment, so that the same reference signs as used in the first embodiment will be used to refer to the components of the drive-force transmitting apparatus 16. In the following description, there will be described control functions of the electronic control apparatus 152 that are partially different from those of the electronic control apparatus 100 of the first embodiment.

The electronic control apparatus 152 includes the engine control portion 120 and a transmission-shifting control means or portion in the form of a transmission-shifting control 154. The engine control portion 120 is the same as that in the above-described first embodiment, and description thereof is not provided.

The transmission-shifting control portion 154 executes a neutral control (hereinafter referred to as a N control) when the vehicle 150 is stopped by depression of a brake pedal of the vehicle 150 with the operation position POSsh of the shift lever 98 being the drive position D. The N control is a control operation that is executed by causing a starting clutch to be partially engaged (slip-engaged) when the vehicle 150 is being stopped, so as to reduce a load acting on the engine 12 for thereby reducing fuel consumption during stop of the vehicle 150. In the drive-force transmitting apparatus 16, the starting clutch corresponds to the first clutch C1 since the vehicle 150 is started by engagement of the first clutch C1. However, the first clutch C1, which is operated by the C1 control pressure Pa controlled by the on-off solenoid valve 91, cannot be partially engaged, so that the N control cannot be executed by causing the first clutch C1 to be partially engaged.

In the present embodiment, when the N control is to be executed, the transmission-shifting control portion 154 executes the N control by causing the second clutch C2 to be partially engaged by controlling the C2 control pressure Pc2 applied to the second clutch C2. Specifically, the transmission-shifting control portion 154 controls the C2 control pressure Pc2 such that the rotational speed difference ΔNc2 is substantially equal to a predetermined difference value, wherein the rotational speed difference ΔNc2 is a difference between rotational speeds of rotary elements that are located on respective front and rear sides of the second clutch C2 in the second drive-force transmitting path PT2. Since the C2 control pressure Pc2 applied to the second clutch C2 can be finely controlled by the linear solenoid valve 94, the N control can be executed by causing the second clutch C2 to be partially engaged.

The electronic control apparatus 152 includes, in addition to the C2-engagement determining portion 128 and C1-engagement determining portion 130, an N-control return determining means or portion in the form of an N-control return determining portion 156. The C2-engagement determining portion 128, C1-engagement determining portion 130 and N-control return determining portion 156 are operated when the vehicle 150 is to be returned from the N control so as to be caused to run (start) in the gear running mode. The control functions of the C2-engagement determining portion 128 and C1-engagement determining portion 130 are the same as those in the above-described first embodiment, and descriptions thereof are not provided.

The N-control return determining portion 156 determines whether the vehicle 150 is being subjected to the N control or not. The N-control return determining portion 156 determines that the N control is being executed on the vehicle 150, for example, when a command requesting execution of the N control is being outputted by the transmission-shifting control portion 154. Further, the N-control return determining portion 156 determines whether a returning request for returning from the N control is made or not. The N-control return determining portion 156 determines that the returning request for returning from the N control is made, for example, when the brake pedal is released during execution of the N control.

When it is determined by the N-control return determining portion 156 that the above-described returning request is made during execution of the N control, the transmission-shifting control portion 154 executes a control operation for returning from the N control, as described below. Firstly, the transmission-shifting control portion 154 outputs a command requesting the second clutch C2 to be switched from the partially engaged state to the engaged state, and the command is supplied to the hydraulic control unit 46, for thereby causing the second clutch C2 to be engaged. Specifically, the transmission-shifting control portion 154 controls the C2 control pressure Pc2 applied to the second clutch C2, for example, such that the input-shaft rotational speed Nin is reduced at a predetermined target rate dNin/dt. Thus, it is possible to reduce a shock generated by change of the input-shaft rotational speed Nin in the process of engagement of the second clutch C2.

When the second clutch C2 has been fully engaged, the inertia phase is terminated and the input-shaft rotational speed Nin is made zero. In this instance, when it is determined by the C2-engagement determining portion 128 that the second clutch C2 has been fully engaged, the transmission-shifting control portion 154 outputs a command requesting the first clutch C1 to be engaged, and the outputted command is supplied to the hydraulic control unit 46, for thereby causing the first clutch C1 to be engaged. The first clutch C1 as well as the second clutch C2 is placed in the engaged state when the first clutch C1 is engaged. However, the gear ratio EL established in the first drive-force transmitting path PT1 is higher than the highest gear ratio max established in the second drive-force transmitting path PT2, so that the transmission of the drive force along the first drive-force transmitting path PT1 is disconnected by the two-way clutch TWC. Thus, in the drive-force transmitting apparatus 16, even when the first and second clutches C1, C2 are both in the engaged states, the first and second drive-force transmitting paths PT1, PT2 are avoided from interfering with each other in transmission of the drive force. When it is determined by the C1-engagement determining portion 130 that the first clutch C1 has been fully engaged, the transmission-shifting control portion 154 outputs a command requesting the second clutch C2 to be released, and the outputted command is supplied to the hydraulic control unit 46, for thereby causing the second clutch C2 to be released. In this instance, the C2 control pressure Pc2 applied to the second clutch C2 is gradually reduced at the certain rate L whereby a shock generated in the process of release of the second clutch C2 is reduced. When the C2 control pressure Pc2 of the second clutch C2 becomes zero and the second clutch C2 is fully released, the first drive-force transmitting path PT1 is connected by the two-way clutch TWC whereby the vehicle 150 is enabled to start running in the gear running mode.

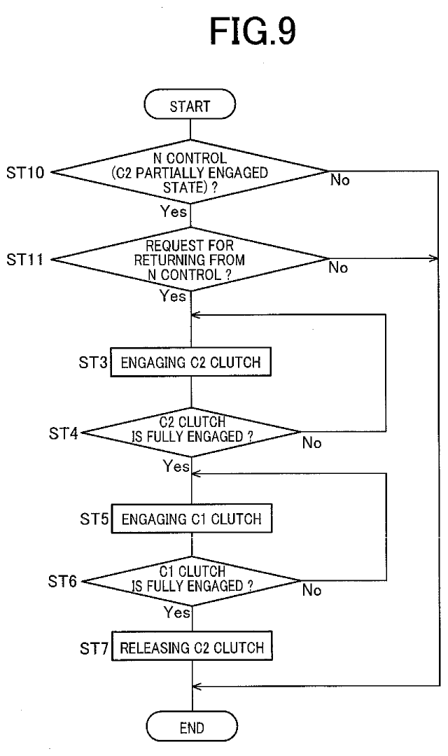

FIG. 9 is a flow chart showing a main part of a control routine executed by the electronic control apparatus 152, namely, a control routine that is executed when the vehicle 150 is to be returned from the N control to the gear running mode so as to run in the gear running mode. This control routine is executed in a repeated manner.

The control routine is initiated with step ST10 corresponding to control function of the N-control return determining portion 156, which is implemented to determine whether the vehicle 150 is being subjected to the N control. When a negative determination is made at step ST10, one cycle of execution of the control routine is completed. When an affirmative determination is made at step ST10, step ST11 corresponding to control function of the N-control return determining portion 156 is implemented to determine whether a request for returning from the N control is made or not. When a negative determination is made at step ST11, one cycle of execution of the control routine is completed. When an affirmative determination is made at step ST11, step ST3 corresponding to control function of the transmission-shifting control portion 154 is implemented to cause the second clutch C2 to be engaged. In this instance, the C2 control pressure Pc2 applied to the second clutch C2 is finely controlled thereby reducing a shock generated in the process of engagement of the second clutch C2. Then, step ST3 is followed by step ST4 corresponding to control function of the C2-engagement determining portion 128, which is implemented to determine whether the second clutch C2 has been fully engaged or not. When a negative determination is made at step ST4, the control flow goes back to step ST3 so as to cause the engaging action of the second clutch C2 to be continued. When an affirmative determination is made at step ST4, step ST5 corresponding to control function of the transmission-shifting control portion 154 is implemented to cause the first clutch C1 to be engaged. Then, step ST6 corresponding to control function of the C1-engagement determining portion 130 is implemented to determine whether the first clutch C1 has been fully engaged or not. When a negative determination is made at step ST6, the control flow goes back to step ST5 so as to cause the engaging action of the first clutch C1 to be continued. When an affirmative determination is made at step ST6, step ST7 corresponding to control function of the transmission-shifting control portion 154 is implemented to cause the second clutch C2 to be released. In this instance, the C2 control pressure Pct applied to the second clutch C2 is gradually reduced whereby a shock generated in the process of release of the second clutch C2 is reduced. When the C2 control pressure Pc2 of the second clutch C2 becomes zero, the vehicle 150 is enabled to run in the gear running mode with the first clutch C1 being engaged.

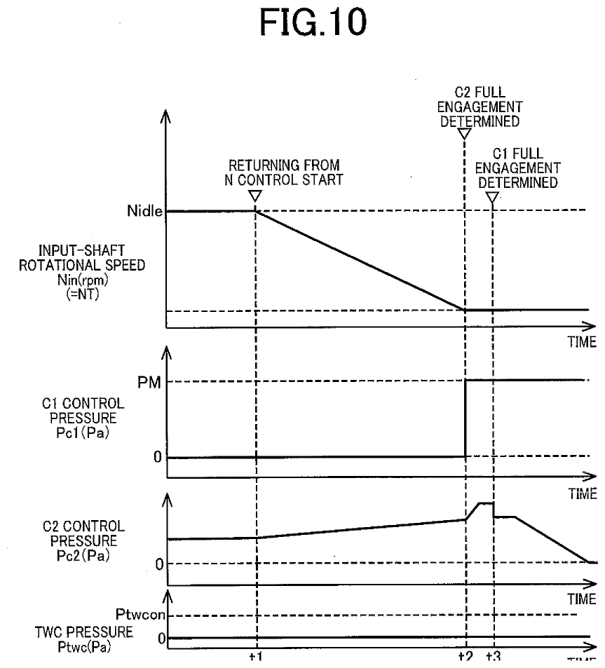

FIG. 10 is a time chart showing a result of the control routine that is executed as shown in the flow chart of FIG. 9, specifically, a result of the control routine that is executed when the vehicle 150 is to be switched back from the N control to the gear running mode.

As shown in FIG. 10, at a point t1 of time at which the request for returning from the N control is made, the second clutch C2 starts to be engaged. In a stage from the point t1 of time to a point t2 of time, the C2 control pressure Pc2 applied to the second clutch C2 is finely controlled by the linear solenoid valve 94 such that the input-shaft rotational speed Nin is reduced at the predetermined target rate dNin/dt. At the point t2 of time at which the second clutch C2 is fully engaged, the input-shaft rotational speed Nin becomes zero. Further, at the point t2 of time, it is determined that the second clutch C2 has been fully engaged, and the first clutch C1 starts to be engaged. The C1 control pressure Pc1 applied to the first clutch C1, which is controlled by the on-off solenoid valve 91, is increased at a step from zero to the modulator pressure PM. In this instance, although the C1 control pressure Pet cannot be finely controlled in the process of engagement of the first clutch C1, it is possible to reduce a shock generated by change of the input-shaft rotational speed Nin in the process of engagement of the first clutch C1, since the input-shaft rotational speed Nin has been already made zero as a result of the full engagement of the second clutch C2. At a point t3 of time at which it is determined that the first clutch C has been fully engaged, the second clutch C2 starts to be released. After the point t3 of time, the C2 control pressure Pc2 applied to the second clutch C2 is temporarily held at a constant value, and then is gradually reduced. With the gradual reduction of the C2 control pressure Pc2, a shock generated in process of release of the second clutch C2 is reduced. When the C2 control pressure Pc2 becomes zero, the first drive-force transmitting path PT1 is connected by the two-way clutch TWC, whereby the vehicle 150 is enabled to start running in the gear running mode.

As described above, the second embodiment provides substantially the same technical advantages as the above-described first embodiment. That is, in the second embodiment, it is possible to reduce the shock generated when the vehicle is returned from the N control to the gear running mode.

While the preferred embodiments of this invention have been described in detail by reference to the drawings, it is to be understood that the invention may be otherwise embodied.

For example, in the above-described embodiments, the drive-force transmitting apparatus 16 defines the first and second drive-force transmitting paths ST1, ST2 provided in parallel with each other between the input shaft 22 and the output shaft 30, such that the first drive-force transmitting path PT1 is provided with the first clutch C1 and the two-way clutch TWC while the second drive-force transmitting path PT2 is provided with the continuously variable transmission 24 and the second clutch C2. However, the above-described construction or arrangement of the drive-force transmitting apparatus 16 is not essential for the present invention. The present invention is applicable to any drive-force transmitting apparatus that is to be provided in a vehicle, wherein the drive-force transmitting apparatus includes an input shaft, an output shaft and first, second and third engagement devices, and defines a plurality of drive-force transmitting paths that are provided with the engagement devices.

Further, the present invention is applicable also to a drive-force transmitting apparatus including a step-variable automatic transmission that is constituted by a plurality of planetary gear devices and a plurality of engagement devices. In the step-variable automatic transmission, each one of a plurality of speed positions is selectively established by a corresponding one of combinations of operation states of the engagement devices. It is possible to interpret that the step-variable automatic transmission defines the same number of drive-force transmitting paths as the speed positions established therein wherein each of the different drive-force transmitting paths is to be established when a corresponding one of the speed positions is established. In the step-variable automatic transmission included in the drive-force transmitting apparatus, to which the present invention is applicable, two of the engagement devices corresponding to the first and third engagement devices are provided in series in one of the drive-force transmitting paths which is to be established when the vehicle is to start running, wherein the engagement device corresponding to the first engagement device is to be operated by a hydraulic pressure controlled by an on-off solenoid valve. That is, the present invention is applicable to such a drive-force transmitting apparatus, particularly, to a case in which the vehicle is caused to start running, by engaging the first engagement device serving as a starting clutch during the neutral state, such that the first engagement device is engaged after another one of the engagement devices corresponding to the second engagement device is engaged, for thereby reducing a shock generated in process of the engagement of the first engagement device.

In the above-described embodiments, the third engagement device is constituted by the two-way clutch TWC that is to be placed in a selected one of the one-way mode and the lock mode, such that the two-way clutch TWC transmits the drive force during the driving state of the vehicle and cuts off transmission of the drive force during the driven state of the vehicle when the two-way clutch TWC is placed in the one-way mode, and such that the two-way clutch TWC transmits the drive force during the driving state and during the driven state when the two-way clutch TWC is placed in the lock mode. However, the third engagement device does not necessarily have to be constituted by a two-way clutch having such a construction, but may be constituted, for example, by a conventional one-way clutch that is configured to transmit the drive force during the driving state and to cut off transmission of the drive force during the driven state. Further, where the third engagement device is constituted by a two-way clutch, the two-way clutch may have a construction that is not particularly limited to the details of the above-described two-way clutch TWC.

It is to be understood that the embodiments described above are given for illustrative purpose only, and that the present invention may be embodied with various modifications and improvements which may occur to those skilled in the art.

### NOMENCLATURE OF ELEMENTS

16: drive-force transmitting apparatus
22: input shaft
24: continuously variable transmission
30: output shaft
91: on-off solenoid valve
94: linear solenoid valve
100, 152: electronic control apparatus (control apparatus)
122, 154: transmission-shifting control portion
C1: first clutch (first engagement device, engagement device)
C2: second clutch (second engagement device, engagement device)
TWC: two-way clutch (third engagement device, engagement device)
PT1: first drive-force transmitting path
PT2: second drive-force transmitting path
EL: gear ratio (first gear ratio)
γmax: highest gear ratio (second gear ratio)

What is claimed is:

1. A control apparatus for a drive-force transmitting apparatus that is to be provided in a vehicle,
wherein the drive-force transmitting apparatus includes an input shaft, an output shaft and first, second and third engagement devices, and defines a plurality of drive-force transmitting paths that are provided between the input shaft and the output shaft,
wherein the plurality of drive-force transmitting paths include a first drive-force transmitting path and a second drive-force transmitting path, such that the first drive-force transmitting path is provided with the first and third engagement devices, and such that the third engagement device is located between the first engagement device and the output shaft in the first drive-force transmitting path,
wherein the first drive-force transmitting path is established by engagement of the first engagement device operated by a hydraulic pressure which is applied to the first engagement device and which is controlled by an on-off solenoid valve, such that a drive force is to be transmitted along the first drive-force transmitting path through the first and third engagement devices when the first drive-force transmitting path is established,
wherein the second drive-force transmitting path is established by engagement of the second engagement device operated by a hydraulic pressure which is applied to the second engagement device and which is controlled by a linear solenoid valve, such that the drive force is to be transmitted along the second drive-force transmitting path through the second engagement device when the second drive-force transmitting path is established,
wherein the third engagement device is configured to transmit the drive force during a driving state of the vehicle and to cut off transmission of the drive force during a driven state of the vehicle, and
wherein said control apparatus comprises a transmission-shifting control portion configured, in a case in which the first engagement device is to be placed into an engaged state thereof during a neutral state of the drive-force transmitting apparatus, to cause the first engagement device to be engaged after causing the second engagement device to be engaged, and then to cause the second engagement device to be released upon completion of the engagement of the first engagement device.

2. The control apparatus according to claim 1,
wherein the first drive-force transmitting path provides a first gear ratio between the input and output shafts, and the second drive-force transmitting path provides a second gear ratio between the input and output shafts, such that the first gear ratio is higher than the second gear ratio.

3. The control apparatus according to claim 1,
wherein the transmission-shifting control portion is configured, upon the completion of the engagement of the first engagement device, to cause the hydraulic pressure applied to the second engagement device, to be reduced at a given rate.

4. The control apparatus according to claim 1,
wherein the drive-force transmitting apparatus further includes a continuously-variable transmission,
wherein the first and second drive-force transmitting paths are provided in parallel with each other, and
wherein the second drive-force transmitting path is provided with the continuously-variable transmission.

5. The control apparatus according to claim 1,
wherein the third engagement device is to be placed in a selected one of a one-way mode and a lock mode, such that the third engagement device is configured to transmit the drive force during the driving state of the vehicle and to cut off transmission of the drive force during the driven state of the vehicle when the third engagement device is placed in the one-way mode, and such that the third engagement device is configured to transmit the drive force during the driving state of the vehicle and during the driven state of the vehicle when the third engagement device is placed in the lock mode.

6. The control apparatus according to claim 1,
wherein the third engagement device includes an input-side rotary portion and an output-side rotary portion such that rotation is to be transmitted between the input shaft and the input-side rotary portion along the first drive-force transmitting path and such that rotation is to be transmitted between the output-side rotary portion and the output shaft along the first drive-force transmitting path, and
wherein the input-side rotary portion is inhibited from being rotated in a predetermined one of opposite directions relative to the output-side rotary portion and is allowed to be rotated in the other of the opposite directions relative to the output-side rotary portion.

7. The control apparatus according to claim 6,
wherein the input-side rotary portion of the third engagement device is connected to a first rotary element and is to be rotated integrally with the first rotary element,
wherein the output-side rotary portion of the third engagement device is connected to a second rotary element and is to be rotated integrally with the second rotary element, and
wherein, when the first and second engagement devices are both engaged and the input shaft is rotated, the first and second rotary elements are both rotated such that a rotational speed of the second rotary element is higher than a rotational speed of the first rotary element, whereby the input-side rotary portion of the third engagement device is rotated in said other of the opposite directions relative to the output-side rotary portion of the third engagement device.

8. The control apparatus according to claim 1, comprising an engagement determining portion configured to determine whether each of at least one of the first and second engagement devices is in the engaged state or not, depending on a rotational speed difference between rotational speeds of rotary elements that are located on respective front and rear sides of the each of the at least one of the first and second engagement devices in a corresponding one of the first and second drive-force transmitting paths,
wherein said engagement determining portion is configured to determine that each of the at least one of the first and second engagement devices is in the engaged state, when the rotational speed difference is not larger than a determination threshold value.
